(19) United States
(12) Patent Application Publication
(10) Pub. No.: US 2025/0139459 A1
(43) Pub. Date: May 1, 2025

(54) COMPUTING SYSTEM AND METHOD FOR RAPIDLY QUANTIFYING FEATURE INFLUENCE ON THE OUTPUT OF A DATA SCIENCE MODEL

(71) Applicant: Discover Financial Services, Riverwoods, IL (US)

(72) Inventors: Khashayar Filom, Chicago, IL (US); Alexey Miroshnikov, Scottsdale, AZ (US); Arjun Ravi Kannan, Buffalo Grove, IL (US)

(21) Appl. No.: 18/499,974

(22) Filed: Nov. 1, 2023

(51) Int. Cl. G06N 5/01

(52) U.S. Cl. CPC G06N 5/01

(57) ABSTRACT

A computing platform is configured to (i) receive a request to compute a score for an input data record that comprises a group of actual parameters that map to a set of features that a trained data science model is configured to receive as input; (ii) input the group into the trained data science model that comprises an ensemble of symmetric decision trees; (iii) for each individual decision tree in the ensemble: (a) identify a respective leaf such that the actual parameters satisfy splitting conditions for edges that connect nodes in a respective path from a root of the individual decision tree to the respective leaf, and (b) determine a set of respective individual contribution values for the respective leaf; and (iv) for each individual feature in the set of features, compute a respective overall contribution value based on a sum of the respective individual contribution values.

### BACKGROUND

An increasing number of technology areas are becoming driven by data and the analysis of such data to develop insights. One way to do this is with data science models (e.g., machine-learning models) that may be created based on historical data and then applied to new data to derive insights such as predictions of future outcomes.

In many cases, the use of a given data science model is accompanied by a desire to explain an output of the model, such that an appropriate action might be taken in view of the insight provided. However, many data science models are extremely complex and the manner by which they derive insights can be difficult to analyze. For example, it may not be apparent how the output of a data science model for a particular input data record was influenced by any given feature that the data science model uses as input. Therefore, it can be difficult to interpret which features had the greatest effect on the output generated by the model.

### OVERVIEW

Disclosed herein is a new technique for rapidly, efficiently, and accurately quantifying the influence of specific features (e.g., determining contribution values) on the output of a trained data science model.

In one aspect, the disclosed technology may take the form of a method to be carried out by a computing platform that involves (i) receiving a request to compute a score for an input data record, the input data record comprising a group of actual parameters that map to a set of features that a trained data science model is configured to receive as input; (ii) inputting the group of actual parameters into the trained data science model, wherein the trained data science model comprises an ensemble of decision trees, and wherein: (a) each individual decision tree in the ensemble is symmetric, (b) each individual decision tree in the ensemble is configured to receive a respective subset of the features as input, and (c) within each individual decision tree, internal nodes that are positioned in a same level designate a same splitting criterion based on a same feature selected from the respective subset of features; (iii) for each individual decision tree in the ensemble: (a) identifying a respective leaf such that the actual parameters satisfy a series of splitting conditions for edges that connect nodes in a respective path from a root of the individual decision tree to the respective leaf, and (b) determining a set of respective individual contribution values for the respective leaf, wherein each of the respective individual contribution values maps to a respective feature found in the respective subset of features; (iv) for each individual feature in the set of features, computing a respective overall contribution value based on a sum of the respective individual contribution values that map to that individual feature; and (v) computing, via the trained data science model, the score for the input data record based on the respective leaves identified.

In some examples, the method carried out by the computing platform further involves: (i) identifying at least one reason code for the score based on the respective overall contribution values for the individual features in the set of features; and (ii) transmitting the score and the at least one reason code in response to the request.

Further, in some examples, the method carried out by the computing platform involves: prior to receiving the request, training the trained data science model against training data that comprises a plurality of training data records.

Still further, in some examples, determining the set of respective individual contribution values for the respective leaf comprises: (i) identifying each realizable path from the root of the individual decision tree to each realizable leaf in the individual decision tree, respectively; (ii) for each identified realizable path, computing a respective first probability by dividing a number of the training data records that were scored during the training based on the identified realizable path by a total number of training data records in the training data; (iii) for each identified realizable path, identifying a respective score to be assigned to input data records scored by the identified realizable path; (iv) for each level of the individual decision tree, identifying the same feature on which the same splitting criterion specified by the internal nodes at that level is based; (v) identifying subsets of the respective subset of features that the individual decision tree is configured to receive as input; (vi) for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree; (vii) for each identified subset of the respective subset of features, computing a sum of the respective first probabilities for each realizable path in the identified subset; and (viii) for each identified subset of the respective subset of features, computing a marginal path expectation by multiplying the respective score for the respective path by the sum for the identified subset.

Still further, in some examples, identifying each realizable path from the root of the individual decision tree to each realizable leaf in the individual decision tree, respectively, comprises: (i) identifying a selected path to be evaluated for realizability; (ii) detecting that a first splitting condition for a first edge in the selected path and a second splitting condition for a second edge in the path contradict each other; and (iii) excluding the selected path from a list of realizable paths.

Still further, in some examples, determining the set of respective individual contribution values for the respective leaf comprises: (i) receiving an identifier of a leaf selected from a decision tree in the ensemble; and (ii) based on the identifier of the leaf, determining a set of contribution values to which the identifier maps in a data structure, wherein the determined set of contribution values to which the identifier maps in the data structure is the set of respective individual contribution values.

Still further, in some examples, the method carried out by the computing platform further involves, prior to receiving the request: (i) generating a respective set of contribution values for each leaf in the ensemble of decision trees and (ii) populating the data structure with entries that map the leaves in the ensemble of decision trees to the respective sets of contribution values, wherein generating a respective set of contribution values comprises: (a) identifying each realizable path from the root of the individual decision tree to each realizable leaf in the individual decision tree, respectively; (b) for each identified realizable path, computing a respective first probability by dividing a number of the training data records that were scored during the training based on the identified realizable path by a total number of training data records in the training data; (c) for each identified realizable path, identifying a respective score to be assigned to input data records scored by the identified realizable path; (d) for each level of the individual decision tree, identifying the same feature on which the same splitting criterion specified by the internal nodes at that level is based; (e) identifying subsets of the respective subset of features that the individual decision tree is configured to receive as input; (f) for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree; (g) for each identified subset of the respective subset of features, computing a sum of the respective first probabilities for each realizable path in the identified subset; and (h) for each identified subset of the respective subset of features, computing a marginal path expectation by multiplying the respective score for the respective path by the sum for the identified subset.

In yet another aspect, disclosed herein is a computing platform that includes a network interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

Still further, in some examples, the at least one reason code comprises a model reason code (MRC) or an adverse action reason code (AARC).

In still another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts a simplified block diagram illustrating an example computing environment in which a data science model may be utilized;

FIG. 2 depicts a simplified block diagram illustrating an example data science model that may be executed by a software subsystem of a computing platform according to aspects of the disclosed technology;

FIG. 3A is a flow chart that illustrates one possible example of a precomputation process for determining contribution values for features used in a data science model comprising one or more decision trees in accordance with the present disclosure.

FIG. 3B is a flow chart that illustrates one possible example of a process for calculating contribution values in accordance with the present disclosure;

FIG. 4 is a schematic diagram showing one possible example of grid and a corresponding decision tree with structural characteristics that are unsuitable for use with the processes described in accordance with the present disclosure;

FIG. 5 is a schematic diagram showing one possible example of a grid and a corresponding decision tree with structural characteristics that are suitable for use with the processes described in accordance with the present disclosure;

FIG. 6 is a schematic diagram showing one possible example of an ensemble of decision trees that are suitable for use with the processes described in accordance with the present disclosure; and

FIG. 7 is a simplified block diagram that illustrates some structural components of an example computing platform.

### DETAILED DESCRIPTION

Entities in various industries have begun to utilize data science models to derive insights that may enable those entities, and the goods and/or services they provide, to operate more effectively and/or efficiently. The types of insights that may be derived in this regard may take numerous different forms, depending on the entity utilizing the data science model and the type of insight that is desired. As one example, an entity may utilize a data science model to predict the likelihood that an industrial asset will fail within a given time horizon based on operational data for the industrial asset (e.g., sensor data, actuator data, etc.). As another example, data science models may be used in a medical context to predict the likelihood of a disease or other medical condition for an individual, and/or the result of a medical treatment for the individual.

As yet another example, many entities (e.g., companies or corporations) have begun to utilize data science models to help make certain operational decisions with respect to prospective or existing customers of those entities. For instance, as one possibility, an entity may utilize a data science model to help make decisions regarding whether to extend a service provided by that entity to a particular individual. One example may be an entity that provides services such as loans, credit card accounts, bank accounts, or the like, which may utilize a data science model to help make decisions regarding whether to extend one of these services to a particular individual (e.g., by estimating a risk level for the individual and using the estimated risk level as a basis for deciding whether to approve or deny an application submitted by the individual). As another possibility, an entity may utilize a data science model to help make decisions regarding whether to target a particular individual when engaging in marketing of a good and/or service that is provided by the entity (e.g., by estimating a similarity of the individual to other individuals who previously purchased the good and/or service). As yet another possibility, an entity may utilize a data science model to help make decisions regarding what terms to offer a particular individual for a service provided by the entity, such as what interest rate level to offer a particular individual for a new loan or a new credit card account. Many other examples are possible as well.

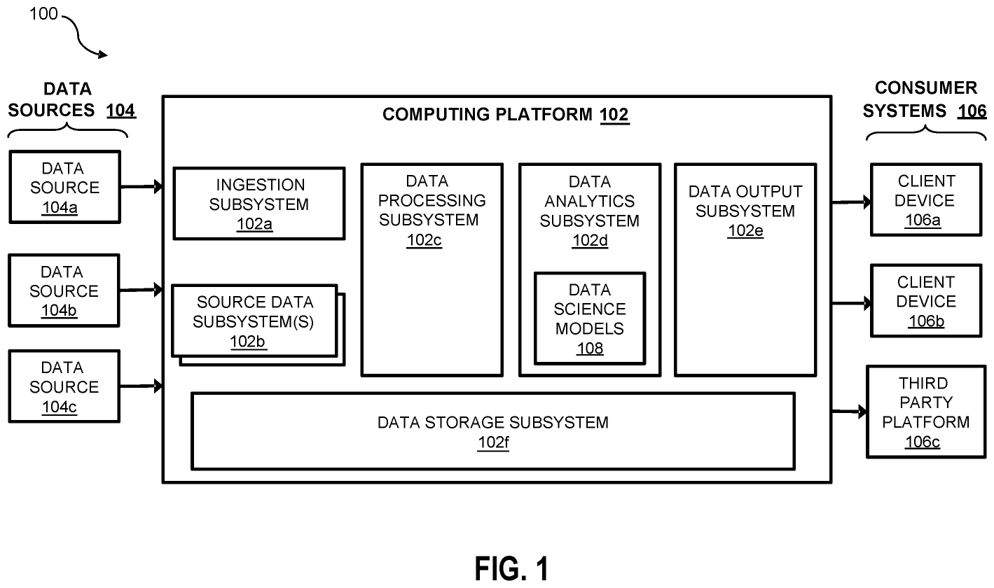

One illustrative example of a computing environment 100 in which an example data science model such as this may be utilized is shown in FIG. 1. As shown, the example computing environment 100 may include a computing platform 102 associated with a given entity, which may comprise various functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of entity operating the example computing platform 102.

Further, as shown in FIG. 1, the example computing platform 102 may comprise one or more source data subsystems 102b that are configured to generate and output source data internally for consumption by the example computing platform 102. These source data subsystems 102b may take any of various forms, which may depend at least in part on the type of entity operating the example computing platform 102.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of entity operating the example computing platform 102. For instance, in line with the present disclosure, data analytics subsystem 102d may be configured to execute data science models 108 for rendering decisions related to the entity's business, such as a data science model for deciding whether to extend a service being offered by the entity to an individual within a population (e.g., a financial service such as a loan, a credit card account, a bank account, etc.), a data science model for deciding whether to target an individual within a population when engaging in marketing of a good and/or service that is offered by the entity, and/or a data science model for deciding what terms to extend an individual within a population for a service being offered by the entity, among various other possibilities. In practice, each of the data science models 108 may comprise a model object that was trained by applying a machine-learning process to a training dataset, although it should be understood that a data science model could take various other forms as well.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the entity (e.g., employees, contractors, etc.) and/or individuals seeking to obtain goods and/or services from the entity. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices 106a-c, among other possibilities.

The data output subsystem 102e may be configured to output data to other types of consumer systems 106 as well.

Referring once more to FIG. 1, the example computing platform 102 may also comprise a data storage subsystem 102f that is configured to store the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, communication interfaces, etc.) that are utilized to implement the functional subsystems discussed herein. This set of physical computing resources may take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise “on-premises” computing resources of the entity that operates the example computing platform 102 (e.g., entity-owned servers). As yet another possibility, the example computing platform 102 may comprise a combination of cloud computing resources and on-premises computing resources. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

It should be understood that computing environment 100 is one example of a computing environment in which a data science model may be utilized, and that numerous other examples of computing environments are possible as well.

Most data science models today comprise a trained model object (sometimes called a trained “regressor”) that is configured to (i) receive input data (e.g., actual parameters) for some set of input variables (e.g., formal parameters), (ii) evaluate the input data, and (iii) based on the evaluation, output a “score” (e.g., a likelihood value). For at least some data science models, the score is then used by the data science model to make a classification decision, typically by comparing the score to a specified score threshold (if the score is quantitative as opposed to categorical), depending on the application of the data science model in question.

These types of trained model objects are generally created by training a machine-learning process to a training dataset that is relevant to the particular type of classification decision to be rendered by the data science model (e.g., a set of historical data records that are each labeled with an indicator of a classification decision based on the historical data record, wherein each training instance in the training dataset includes a label for an individual historical data record and the actual parameters specified in that individual historical data record). In this respect, the machine learning process may comprise any of various machine learning techniques, examples of which may include regression techniques, decision-tree techniques, support vector machine (SVM) techniques, Bayesian techniques, ensemble techniques, gradient descent techniques (e.g., including gradient boosting), and/or neural network techniques, among various other possibilities.

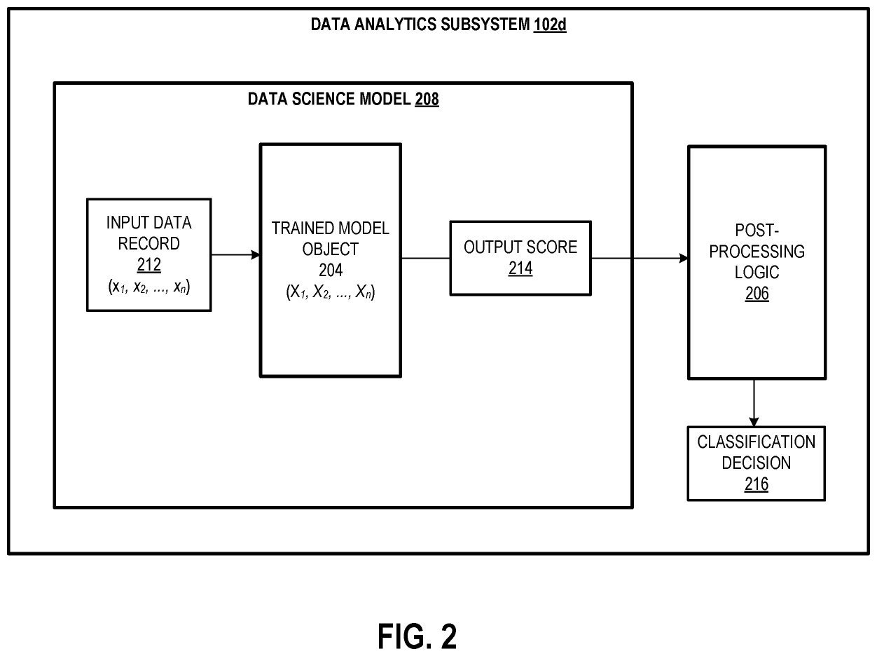

FIG. 2 depicts a conceptual illustration of a data science model 208 for making a classification decision 216 for an input data record 212 in accordance with the present disclosure, which may also be referred to herein as a “classification” model. In the example of FIG. 2, the data science model 208 is shown as being deployed within the example computing platform 102 of FIG. 1 (specifically in the data analytics subsystem 102d of the computing platform 102 of FIG. 1), but it should be understood that the data science model 208 may be deployed within any computing platform that is capable of executing the disclosed data science model 208.

The type of classification decision that is made by the data science model 208 shown in FIG. 2 may take various forms, as noted above. However, for the purposes of FIG. 2 and the examples that follow, the data science model 208 will be referred to as a model for making a decision regarding whether to extend a service (e.g., a loan, a credit card account, a bank account, etc.) being offered by an entity to an individual (e.g., a person or another entity that is capable of being a consumer of the service).

As shown in FIG. 2, the data science model 208 may include a trained model object 204 (e.g., a machine-learning model) that functions to receive the input data record 212 (e.g., an input instance). The input data record 212 includes a set of actual parameters that are represented in FIG. 2 by the set (x₁, x₂, . . . , xₙ). The actual parameters map to a set of formal parameters (e.g., sometimes also referred to as “feature variables,” “features,” or “predictors”) that are used by the trained model object 204 and are represented in FIG. 2 by the set (X₁, X₂, . . . , Xₙ). In this regard, the input data record 212 may include data corresponding to a given individual for whom a classification decision will be made, and may generally comprise data for any variables that may be predictive of whether the given individual is likely to fulfill one or more requirements associated with the service (e.g., variables that provide information related to credit score, credit history, loan history, work history, income, debt, assets, etc.). For example, if the individual is applying for a loan, one requirement associated service may be that the loan be repaid with a certain level of interest after a certain period of time elapses.

In some implementations, the data science model 208 may initially receive source data (e.g., from one or more of the data sources 104 shown in FIG. 1) that may not correspond directly to the input formal parameters specified by the trained model object 204, and/or may include extraneous data that is not used by the trained model object 204, and so on. In these situations, the data science model 208 may first apply pre-processing logic (not shown) to derive, from the source data, the actual parameters that map to the formal parameters that are used by the trained model object 204. In other implementations, the data processing subsystem 102c shown in FIG. 1 may receive the source data from which the actual parameters are derived and may perform the pre-processing logic discussed above (or a portion thereof) before passing the result to the data analytics subsystem 102d and the data science model 208. Other implementations are also possible.

Once the input data record 212 including the actual parameters (x₁, x₂, . . . , xₙ) is received by the trained model object 204 as input, the trained model object 204 may evaluate the input data record 212 based on the actual parameters. Based on the evaluation, the trained model object 204 may determine and output a score 214 that represents a likelihood that the given individual will fulfill one or more requirements associated with the service. For example, the output score 214 may represent a likelihood (e.g., a value between 0 and 1) that the given individual will default on a loan if the loan is extended to the given individual. As further shown in FIG. 2, the data analytics subsystem 102d may then apply post-processing logic 206 to the output score 214 of the data science model 208 in order to render a classification decision 216. For instance, if the output score 214 is above a given threshold, the data analytics subsystem 102d may render a decision not to extend the loan to the individual (e.g., to deny the individual's application for the loan). As another possibility, if the output score 214 is below the given threshold, and additionally below an additional preferred-rate threshold, the data analytics subsystem 102d may render a decision to approve the individual's loan application at a lower interest rate than may be offered to another approved individual for whom the trained model object 204 output a score above the preferred-rate threshold. Various other examples are also possible.

There are various advantages to using a data science model comprising a trained model object (e.g., a machine-learning model) over other forms of data analytics that may be available. As compared to human analysis, data science models can drastically reduce the time it takes to make decisions. In addition, data science models can evaluate much larger datasets (e.g., with far more parameters) while simultaneously expanding the scope and depth of the information that can be practically evaluated when making decisions, which leads to better-informed decisions. Another advantage of data science models over human analysis is the ability of data science models to reach decisions in a more objective, reliable, and repeatable way, which may include avoiding any bias that could otherwise be introduced (whether intentionally or subconsciously) by humans that are involved in the decision-making process, among other possibilities.

Data science models may also provide certain advantages over alternate forms of machine-implemented data analytics like rule-based models (e.g., models based on user-defined rules). For instance, unlike most rule-based models, data science models are created through a data-driven process that involves analyzing and learning from the historical data, and as a result, data science models are capable of deriving certain types of insights from data that are simply not possible with rule-based models—including insights that are based on data-driven predictions of outcomes, behaviors, trends, or the like, as well as other insights that could not be revealed without a deep understanding of complex interrelationships between multiple different data variables. Further, unlike most rule-based models, data science models are capable of being updated and improved over time through a data-driven process that re-evaluates model performance based on newly available data and then adjusts the data science models accordingly. Further yet, data science models may be capable of deriving certain types of insights (e.g., complex insights) in a quicker and/or more efficient manner than other forms of data analytics such as rule-based models. Depending on the nature of the available data and the types of insights that are desired, data science models may provide other advantages over alternate forms of data analytics as well.

When using a data science model comprising a trained model object (e.g., a machine-learning model), it may be desirable to quantify or otherwise evaluate the extent to which different parameters influence or contribute to the model object's output. This type of analysis of the contribution (sometimes also referred to as attribution) of the parameters to a model's output may take various forms.

For instance, it may be desirable in some situations to determine which parameters contribute most heavily to a decision made based on a model object's output on a prediction-by-prediction basis. Additionally, or alternatively, it may be desirable in some situations to determine which parameters contribute most heavily, on average, to the decisions made based on a model object's output over some representative timeframe.

As one example, and referring to the discussion of FIG. 2 above, entities that deny applications for credit (e.g., loan applications) are subject to regulations that oblige those entities to inform the denied individuals as to which factors contributed most to those denials. In this regard, the factors provided to the denied individuals can be referred to as Model Reason Codes (MRCs), sometimes referred to as simply “reason codes.” For example, in the United States, the Equal Opportunity Credit Act (ECOA) mandates that entities that deny applications for credit supply denied individuals with one or more adverse action reason codes (AARCs). Consequently, an entity that utilizes a data science model to make these types of classification decisions should also be prepared to interpret the resulting decisions and identify the corresponding reason codes.

As another example, an entity that manages industrial assets may want to identify the parameters that contributed most to a failure prediction for a given asset. For instance, if a contribution value for a parameter corresponding to particular sensor data or actuator data gathered from the industrial asset is greater than the contribution values of other parameters, a reason for the predicted failure might be readily inferred. This information, in turn, may then help guide the remedial action that may be taken to avoid or fix the problem before the failure occurs in the given asset and/or in other similarly situated assets. If a temperature reading (e.g., an actual parameter that maps to a formal parameter used by the trained model object to represent temperature) from a temperature sensor attached to a polyvinyl chloride (PVC) pipe has a contribution value that greatly exceeds the contribution values of other parameters used by a trained model object, technicians might readily conclude that the predicted failure of the PVC pipe is due to an ambient temperature that approaches or exceeds an upper-bound operating temperature for PVC (e.g., 140 degrees Fahrenheit).

As yet another example, a medical entity that uses data science models to predict the likelihood of disease or other medical conditions for individuals may want to identify the parameters that contributed most to the model's output score for a given individual. This information may then be used to make judgments about the treatments for the individual that may be effective to reduce the likelihood of the disease or medical condition.

Another situation where it may be desirable to analyze the contribution of the parameters used by a model object to the model's output is to determine which parameters contribute most heavily to a bias exhibited by the model object. At a high level, this may generally involve (i) using the model object to score input datasets for two different subpopulations of people (e.g., majority vs. minority subpopulations), (ii) quantifying (e.g., averaging) the contributions of the input variables to the scores for the two different subpopulations, and (iii) using the contribution values for the two different subpopulations to quantify the bias contribution of the variables.

Further details regarding these and other techniques for determining which input variable(s) contribute most heavily to a bias exhibited by a model object can be found in U.S. patent application Ser. No. 17/900,753, which was filed on Aug. 31, 2022, is entitled “COMPUTING SYSTEM AND METHOD FOR CREATING A DATA SCIENCE MODEL HAVING REDUCED BIAS,” and is incorporated herein by reference in its entirety.

Note that this type of analysis may not be trivial. Depending on the complexity or structure of the model object, the contribution or influence of a formal parameter might not be constant across different values of actual parameters that map to that same formal parameter. For example, suppose that a first input data record includes “30,000” as an actual parameter that maps to a formal parameter representing annual salary and “815” as an actual parameter that maps to a formal parameter representing credit rating. Also suppose that a second input data record includes “200,000” as an actual parameter that maps to the formal parameter representing annual salary and “430” as an actual parameter that maps to the formal parameter representing credit rating. Also suppose that the model object outputs scores for both the first input data record and the second input data record that do not satisfy a threshold condition for loan approval. The score for the first input data record may have been influenced primarily by the annual salary parameter, while the score for the second input data record may have been influenced primarily by the credit rating parameter. Thus, the influence of a particular formal parameter on a score may vary based both on the corresponding actual parameter and on the actual parameters that correspond to other formal parameters. As the number of formal parameters the model object uses increases, the complexity of determining the contributions of individual parameters may increase exponentially.

Several techniques have been developed for quantifying the contribution of a trained model object's parameters. These techniques, which are sometimes referred to as “interpretability” techniques or “explainer” techniques, may take various forms. As one example, a surrogate linear function in a simplified space is used in Local Interpretable Model-agnostic Explanations (LIME), and the linear function is used for explaining the output. Another example technique is Partial Dependence Plots (PDP), which utilizes the model object directly to generate plots that show the impact of a subset of the parameters in the overall input data record (also referred to as the “predictor vector”) on the output of the model object. PDP is similar to another technique known as Individual Conditional Expectation (ICE) plots, except an ICE plot is generated by varying the value of a single actual parameter in a specific input data record while holding the values of other actual parameters constant, whereas a PDP plot is generated by varying a subset of the parameters after the complementary set of parameters has been averaged out. Another technique known as Accumulated Local Effects (ALE) takes PDP a step further and partitions the predictor vector space and then averages the changes of the predictions in each region rather than the individual parameters.

Yet another explainer technique is based on the game-theoretic concept of the Shapley value described in Shapley, “A Value for n-Person Games,” in Kuhn and Tucker, CONTRIBUTIONS TO THE THEORY OF GAMES II, Princeton University Press, Princeton, 307-317 (1953), available at https://doi.org/10.1515/9781400881970-018, which is incorporated by reference herein in its entirety. Given a cooperative game with n players, a set function v that acts on a set N:={1, 2, . . . n} and satisfies v(Ø)=0, the Shapley values assign contributions to each player i∈N to the total payoff v(N), and is given by

$${ϕ}_{i} [ v ] = {\sum }_{S ⊆ N \backslash \{ i \}} \frac{s ! ( n - s - 1 ) !}{n !} ( v ( S ⋃ \{ i \} ) - v ( S ) ) , s := \vert S \vert , n := \vert N \vert$$

by considering the possible combinations of a player i and the rest of the players.

In the machine learning setting, the features (e.g., formal parameters) X=(X₁, X₂, . . . . Xₙ) are viewed as n players with an appropriately designed game v(S; x, X, f) where x is an observation (e.g., an actual parameter; a predictor sample from the training dataset of features D_{X}), X is a random vector of features, and f corresponds to the model object and S⊆N. The choice of the game is crucial for a game-theoretic explainer (see Miroshnikov et al. 2021, which is cited below); it determines the meaning of the attribution (explanation) value. Two notable games in the ML literature are the conditional and marginal games given by

$${v}^{CE} ( S ; x , X , f ) = 𝔼 [ f ( X ) \vert {X}_{S} = {x}_{S} ] and$$

$${v}^{ME} ( S ; x , X , f ) = 𝔼 [ f ( {x}_{S} , {X}_{- S} ) ]$$

introduced in Lundberg and Lee (2017). Shapley values of the conditional game—i.e., conditional Shapley values—explain predictions f(X) viewed as a random variable, while Shapley values for the marginal game—i.e., marginal Shapley values—explain the (mechanistic) transformations occurring in the model f(x).

In practice, conditional or marginal games are typically replaced with their empirical analogs that utilize data samples. Computing conditional game values is generally infeasible when the predictor dimension (i.e., the number of formal parameters) is large; this might be considered the curse of dimensionality. The marginal game, however, is often approximated with the empirical marginal game \hat{v}^{ME}(S; x, D̅_{X}, f) given by

$${\hat{v}}^{ME} ( S ; x , {\overline{D}}_{X} , f ) := \frac{1}{\vert {\overline{D}}_{X} \vert} {\sum }_{\tilde{x} ∈ {\overline{D}}_{X}} f ( {x}_{S} , {\tilde{x}}_{- S} )$$

where D̅_{X} is a background dataset of a vector of features, a subset of the dataset D_{X} containing a vector of features X used for training (e.g., the input data record 212 shown in FIG. 2, including actual parameters x₁, X₂, . . . . Xₙ stored in D_{X} that are samples corresponding to the formal parameters X₁, X₂, . . . . Xₙ).

The marginal Shapley value ϕᵢ[v^{ME}] of the feature indexed by the subscript i at x, that is the Shapley value for the game v^{ME}(S; x, X, f), takes into account the set of possible combinations between a feature of interest (e.g., the parameter whose contribution is to be determined) and the rest of the features in the input vector and produces a score (e.g., a scalar value) that represents the contribution of that feature to the deviation of the model prediction for the specific instance of the input vector (e.g., the actual parameters x₁, X₂, . . . . Xₙ) from the model's average prediction. The empirical marginal Shapley value ϕᵢ[\hat{v}^{ME}] is the statistical approximant of ϕᵢ[v^{ME}], which has complexity of the order O(2ⁿ|D̅_{X}|) and represents the number of terms in the Shapley formula times the number of evaluations over the size (e.g., cardinality, as indicated by the operator |⋅|) of the dataset D̅_{X}.

In the remaining parts of the document, the term “Shapley values” (or “marginal Shapley values”), refers to the Shapley values ϕᵢ[v^{ME}], i=1, 2, . . . n, of the marginal game, The Shapley values are denoted by ϕᵢ^{ME} or ϕᵢ^{ME}(x) where the information on the model f and the random variable X is suppressed.

Marginal Shapley values, as discussed herein, generate individual contributions of predictor values. It will be appreciated that the marginal Shapley value often cannot be computed because it presupposes knowledge of the distribution of X. While the evaluation of the empirical marginal game \hat{v}^{ME}(S; x, D̅_{X}, f) is relatively tractable (if the background dataset is small), to evaluate the empirical marginal Shapley value itself is expensive to compute because the Shapley value formula contains the summation over the possible subsets S⊆N, leading to 2ⁿ terms. The complexity can quickly result in intractability if the number of features n is large. If the background dataset is large (e.g., it is chosen to be the training dataset), then evaluating the empirical marginal game alone also becomes computationally expensive.

One practical implementation of using Shapley values to quantify variable contributions is an algorithm referred to as KernelSHAP, described in Lundberg et al., “S. M. Lundberg and S.-I. Lee, A unified approach to interpreting model predictions”, 31st Conference on Neural Information Processing Systems, (2017), which is incorporated by reference herein in its entirety. KernelSHAP is utilized to compute the marginal Shapley value for each input variable. The KernelSHAP method approximates Shapley values for the marginal game (in view of the assumption of feature independence made by the authors) via a weighted least square problem and it is still very expensive computationally when the number of predictors is large.

Another algorithm, called TreeSHAP, described in Lundberg et al., “Consistent individualized feature attribution for tree ensembles,” ArXiv, arxiv:1802.03888 (2019), which is incorporated by reference herein in its entirety, is utilized to compute the Shapley value of a specially designed tree-based game which mimics the conditioning of the model by utilizing the tree-based model structure. The (path-dependent) TreeSHAP algorithm is a fast method in which the training data does not have to be retained to determine contribution values, but in general it produces neither marginal nor conditional Shapley values (nor their approximants) when dependencies between predictors exist. Furthermore, the contribution values it produces can vary based on implementation details. In terms of complexity, the path-dependent algorithm runs in O(T·L·log(L)²) time, where T is the number of trees comprising the model and L is the upper-bound number of leaves. For one to obtain marginal Shapley values, an adaptation of the TreeSHAP algorithm was proposed called Interventional TreeSHAP, described in Lundberg et al., “From local explanations to global understanding with explainable AI for trees”, Nature Machine Intelligence 2, 56-67 (2020), which is incorporated herein by reference in its entirety. It is not as fast as the path-dependent version of the algorithm because it averages over a background dataset D̅_{X} to compute the empirical marginal expectations. However, the complexity is linear in the number of samples (e.g., training instances), and specifically Interventional TreeSHAP has complexity O(T·|D̅_{X}|·L), where again T is the number of trees and L is the upper-bound number of leaves. Note that the values produced by TreeSHAP are model-specific and, in the case of the path-dependent algorithm, they depend on the make-up of the tree-model f(x) in terms of trees: for two different make-ups of some tree-based model f(x), the attribution values will generally differ; this is generally not desirable for an application such as the production of reason codes.

KernelSHAP (which is model agnostic) is relatively slow due to computational complexity, so it is limited in its application when the number of features is large. Furthermore, KernelSHAP assumes independence between features. On the other hand, TreeSHAP is limited because its path-dependent version produces attributions (e.g., contribution values) that may not be conditional Shapley values and its interventional version requires a background dataset to be used.

In general, a marginal Shapley value may represent, for a given input data record x that was scored by a trained model object f(x), a value (e.g., an “explanation” value or a contribution value) for each parameter that indicates the parameter's contribution to the model's output score for the given input data record. For example, if a trained model object's output is a regressor score (i.e., a probability value with value between 0 and 1) a marginal Shapley value may be expressed as a number between −1 and 1, with a positive value indicating a positive contribution to the output and a negative value indicating a negative contribution to the output. Further, the magnitude of the marginal Shapley value may indicate the relative strength of its contribution.

In this regard, it will be understood that a marginal Shapley value for a given parameter should be interpreted in view of how the data science model defines its output. Returning to the example discussed in FIG. 2 above, the trained model object 204 may be trained to output a score that indicates a likelihood that an individual will fulfill one or more requirements associated with the service, where a higher score indicates that the individual is less likely to fulfill the one or more requirements. Accordingly, a positive Shapley value for any of the parameters X₁, X₂, . . . . Xₙ in FIG. 2 would indicate that the parameter contributed to pushing the score higher. On the other hand, a negative Shapley value for any of the parameters X₁, X₂, . . . . Xₙ would indicate that the parameter contributed to pushing the risk score lower.

One of the drawbacks of the explainer techniques discussed above is that they fail to account for dependencies between input variables (this is relevant to both KernelSHAP and TreeSHAP). KernelSHAP generally treats input variables as independent from each other (which is often not the case in practice). TreeSHAP relies on the structure of the regression trees that make up the model and its path-dependent version only partially respects dependencies.

To address these and other shortcomings with the techniques discussed above, disclosed herein is a new approach that facilitates rapid computation and retrieval of contribution values for features used by model objects that satisfy several strategic constraints. Specifically, this approach exploits advantages that can be gained by creating an ensemble of decision trees whose structures satisfy specific structural constraints that are described herein.

When the decision trees in the ensemble satisfy these structural constraints (e.g., the decision trees are oblivious), the formula to determine marginal Shapley values for features used by a decision tree can be simplified to obtain a formula of lower computational complexity. When this simplified formula is leveraged in the context of a computing system, the computational efficiency of that system is increased such that the amount of computing resources (e.g., processor cores or memory) used to accomplish a task in a target amount of time can be greatly reduced. For example, suppose an ensemble of decision trees is used to classify a given input data record. Further suppose Shapley values are desired for features on which decision trees in the ensemble split so that the reasons why the ensemble assigned a particular output class to the input data record features will be more apparent. If no precomputations (which will be described in greater detail below) have been performed beforehand, methods described herein can be used to compute the Shapley values for the features with a computational complexity of log (L)·L^{1.6} (for a fixed observation), where L denotes the number of leaves in the ensemble of decision trees included in a data science model. While the computational complexity of L^{1.6} constitutes an advantage over the techniques mentioned above for computing Shapley values, even greater advantages can be gained by performing precomputations as described below.

Regarding these precomputations, as will be explained in the examples below, the set of contribution values (e.g., marginal Shapley values, Owen values, etc.) for the features used by a decision tree that satisfies the aforementioned structural constraints is constant across input data records that land in the same leaf. As a result, leaves can be mapped to sets of contribution values (rather than individual input data records alone to contribution values on a case-by-case basis) such that the set of Shapley values for an input data record can be inferred directly from the leaf in which the input data record falls. Since leaves can be mapped to contribution values, the set of contribution values to which a leaf maps can be determined via precomputation beforehand and stored in a data structure (e.g., a lookup table) that maps leaves to sets of contribution values for the features on which a decision tree splits. The method of computational complexity L^{1.6} mentioned above can therefore be used to determine the contribution values to which each leaf in each decision tree in an ensemble maps before any input records are classified. The complexity of precomputing the contribution values across each leaf in the ensemble is the number of leaves L multiplied by the complexity L^{1.6} of determining the contribution values for a single leaf. Therefore, the complexity of precomputing the contribution values across each leaf in the ensemble is L*L^{1.6}=L^{2.6}. In practice, for a single tree, the precomputation of the contribution values for the leaves in the tree can be completed in less than one second. Collectively, for multiple trees included in an ensemble, if the depth of the trees in the ensemble does not exceed fifteen, the number of trees in the ensemble does not exceed one thousand, and sufficient processors and memory are engaged, the collective precomputation of the contribution values for the leaves in the ensemble can be completed in a matter of minutes. If the depth of the trees is less than fifteen (e.g., nine) and the number of trees in the ensemble is less than one thousand (e.g., six hundred fifty), the collective precomputation of the contribution values for the leaves in the ensemble can be completed in a few minutes (e.g., 182 seconds without threading or 45 seconds with thirty-two threads).

Once the precomputation has been completed and the results have been stored in a data structure such as a lookup table, the set of contribution values for the features which an ensemble uses to classify an input data record can be determined with logarithmic complexity rather than exponential complexity. This is because the complexity of identifying the leaves of the trees in the ensemble into which the input data record lands is an operation of logarithmic complexity. Specifically, for each respective decision tree in the ensemble, identifying the leaf into which the input data record lands amounts to traversing a path through the respective decision tree from the root to a leaf. The respective decision tree is binary, so finding the leaf into which the input data record lands for the respective tree is O(Log(L)) (where L is the number of leaves in the respective tree). There are T decision trees in the ensemble and the input data record will land in a respective leaf in each of those trees, so identifying the leaves in the ensemble into which the input data record falls is O(T·Log(L)). Once the leaves in which the input data record lands are known, the contribution values to which those leaves map can be retrieved from the data structure (lookup table) via an O(1) lookup operation for each tree in the ensemble. Given the additive property of certain types of contribution values (e.g., marginal Shapley values), the contribution values for the ensemble as a whole can be readily computed by summing the contribution values for the individual decision trees. In practice, this results in a system that greatly reduces the latency involved in determining contribution values. Specifically, the time of computation for the contribution values for the ensemble as a whole (e.g., for an instance defined by an input data record that represents an individual) is about 0.0001 seconds. Thus, sets of contribution values for ten thousand individuals can be determined in one second.

Furthermore, the data needed to perform the methods described herein is contained in the decision trees themselves. As a result, the contribution values can be computed without access to the training dataset that was used to train the ensemble. This provides another advantage over existing approaches (e.g., Interventional TreeSHAP) that involve accessing training data to calculate game values because memory usage is greatly reduced in cases where the training dataset is large (a common occurrence in many industries, since larger training datasets tend to yield better machine-learning models). The processes and systems described herein can therefore be deployed in computing environments that might lack sufficient memory to store a complete training dataset. The processes and systems described herein thus empower such computing environments to perform tasks that those computing environments would not be able to perform if previous approaches were to be used.

The Categorical Boosting (CatBoost) algorithm (which is familiar to those of ordinary skill in the art) uses gradient boosting to produce an ensemble of decision trees that meet the constraints discussed above. CatBoost can be used without modification in conjunction with the processes disclosed herein. The ensembles produced by CatBoost achieve levels of prediction accuracy comparable to those of other types of machine-learning models (e.g., neural networks) that, although capable of achieving high levels of prediction accuracy, do not lend themselves to having those predictions explained in terms of how much each feature influenced any particular prediction. In addition, the running time for CatBoost is generally less than the running time for other machine-learning algorithms (e.g., XGBoost) that can achieve comparable levels of prediction accuracy. There are some types of machine-learning models (e.g., explainable boosting machines and explainable neural networks) that do lend themselves to having their predictions explained, but those models typically fail to achieve the levels of prediction accuracy of their non-explainable counterparts. When implemented as part of the systems and processes described herein, CatBoost can offer the best of both worlds by achieving high prediction accuracy while also providing the option to obtain explanations for individual predictions via the simplified formula and the other techniques described herein.

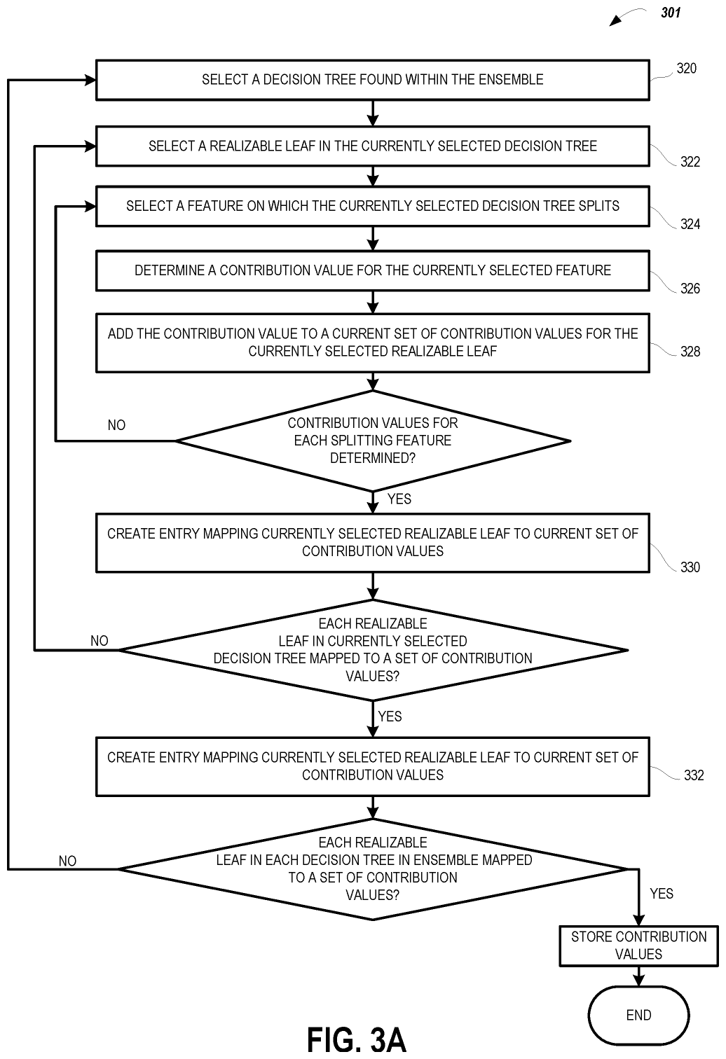

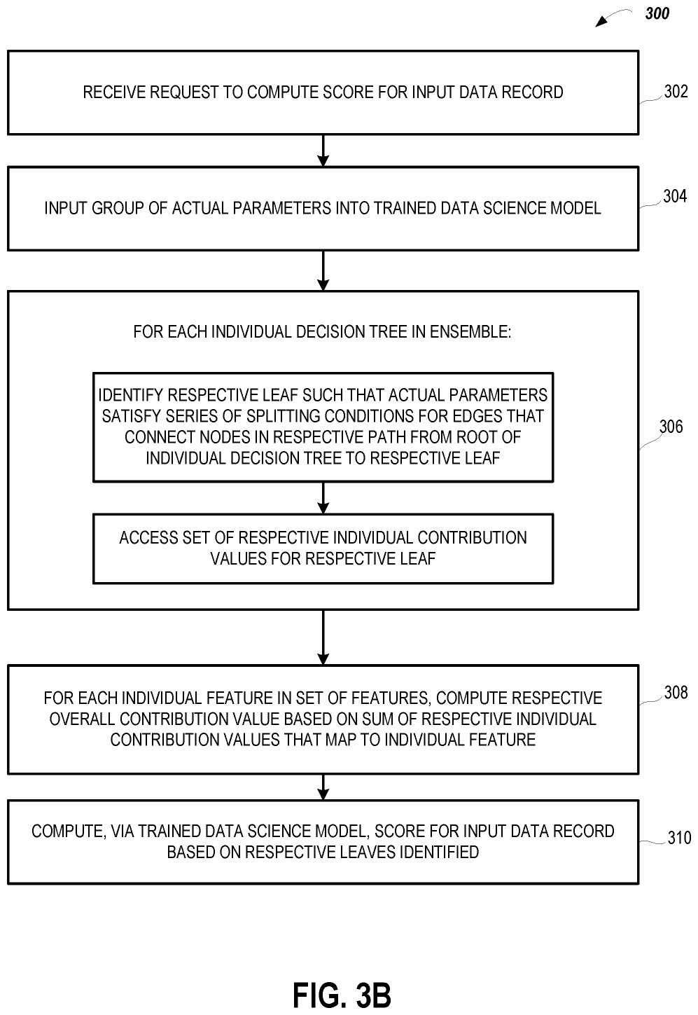

Turning to FIG. 3A, a flow chart is shown that illustrates one example of a precomputation process for determining contribution values for features used in a data science model comprising one or more decision trees in accordance with the present disclosure. The example process 301 may be carried out by any computing platform that is capable of creating a data science model, including but not limited to the computing platform 102 of FIG. 1. Further, it should be understood that the example process 310 of FIG. 3 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

Prior to commencement of the example process 301, a model object for a data science model that is to be deployed by an entity for use in making a particular type of decision may be trained. In general, this model object may comprise any model object that is configured to (i) receive an input data record comprising a set of actual parameters that are related to a respective individual (e.g., person) and map to a particular set of formal parameters (which may also be referred to as the model object's “features” or the model object's “predictors”), (ii) evaluate the received input data record, and (iii) based on the evaluation, output a score that is then used make the given type of decision with respect to the respective individual. Further, the model object that is trained may take any of various forms, which may depend on the particular data science model that is to be deployed.

For instance, as one possibility, the model object may comprise a model object for a data science model to be utilized by an entity to decide whether or not to extend a particular type of service (e.g., a loan, a credit card account, a bank account, or the like) to a respective individual within a population. In this respect, the set of formal parameters for the model object may comprise data variables that are predictive of whether or not the entity should extend the particular type of service to a respective individual (e.g., variables that provide information related to credit score, credit history, loan history, work history, income, debt, assets, etc.), and the score may indicate a likelihood that the entity should extend the particular type of service to the respective individual, which may then be compared to a threshold value in order to reach a decision of whether or not to extend the particular type of service to the respective individual.

The function of training the model object may also take any of various forms, and in at least some implementations, may involve applying a machine-learning process to a training dataset that is relevant to the particular type of decision to be rendered by the data science model (e.g., a set of historical data records for individuals that are each labeled with an indicator of whether or not a favorable decision should be rendered based on the historical data record). In this respect, the machine-learning process may comprise any of various machine learning techniques, examples of which may include regression techniques, decision-tree techniques, support vector machine (SVM) techniques, Bayesian techniques, ensemble techniques, gradient descent techniques, and/or neural-network techniques, among various other possibilities.

As shown in FIG. 3A, the example process 301 may begin at block 320 by selecting a decision tree found within an ensemble of decision trees included in the data science model.

As shown in block 322, the example process 301 further includes selecting a realizable leaf in the currently selected decision tree.

As shown in block 324, the example process 301 further includes selecting a feature on which the currently selected decision tree splits.

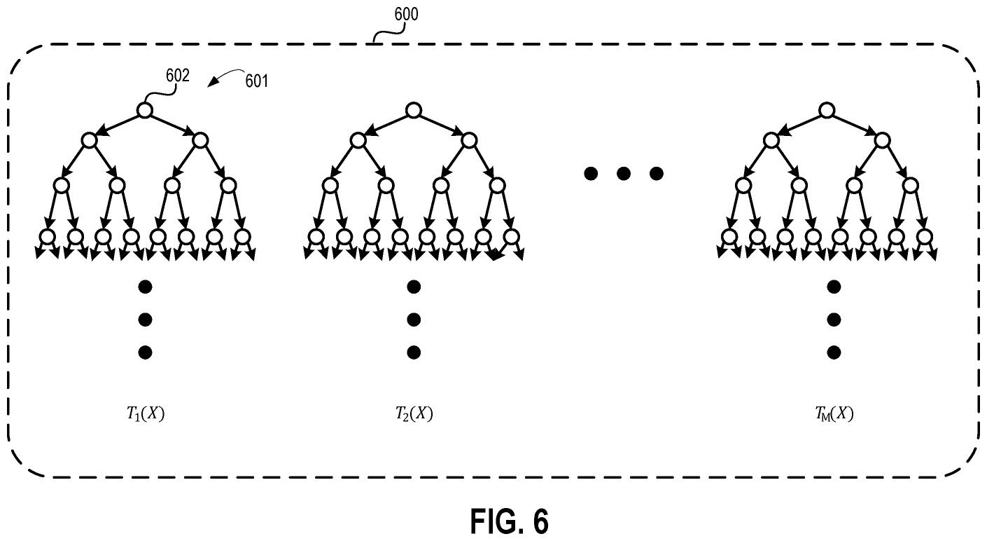

As shown in block 326, the example process 301 further includes determining a contribution value for the currently selected feature. The contribution value may be determined, for example, using the approach described below with respect to FIG. 6.

As shown in block 328, the example process 301 may further include adding the contribution value to a current set of contribution values for the currently selected realizable leaf. If contribution values for each feature on which the currently selected decision tree splits have been determined, the flow of the example process 301 moves to block 330. Otherwise, the flow of the example process 301 moves back to block 324 for the next feature on which the currently selected decision tree splits to be selected.

As shown in block 330, if contribution values for each feature on which the currently selected decision tree splits have been determined, an entry that maps the currently selected realizable leaf to the current set of contribution values is created. If there are entries in data structure that map each realizable leaf in the currently selected decision tree to a respective set of contribution values, the flow of the example process 301 moves to block 332. Otherwise, the flow of the example process 301 moves to block 322 for the next realizable leaf to be selected.

As shown in block 332, if the realizable leaves in each decision tree in the ensemble have been mapped to contribution values, the example process 301 terminates after storing the contribution values (e.g., in a computer-readable storage medium for future retrieval). Otherwise, the flow of the example process 301 moves back to block 320 so that the next decision tree in the ensemble can be selected. In this manner, the data structure that maps realizable leaves in the ensemble to sets of contribution values can be populated.

Turning to FIG. 3B, a flow chart is shown that illustrates one example of a process 300 for determining contribution values for features used in a data science model comprising one or more decision trees in accordance with the present disclosure. The example process 300 of FIG. 3B may be carried out by any computing platform that is capable of creating a data science model, including but not limited to the computing platform 102 of FIG. 1. Further, it should be understood that the example process 300 of FIG. 3B is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

Prior to commencement of the example process 300, a model object for a data science model that is to be deployed by an entity for use in making a particular type of decision may be trained. In general, this model object may comprise any model object that is configured to (i) receive an input data record comprising a set of actual parameters that are related to a respective individual (e.g., person) and map to a particular set of formal parameters (which may also be referred to as the model object's “features” or the model object's “predictors”), (ii) evaluate the received input data record, and (iii) based on the evaluation, output a score that is then used make the given type of decision with respect to the respective individual. Further, the model object that is trained may take any of various forms, which may depend on the particular data science model that is to be deployed.

For instance, as one possibility, the model object may comprise a model object for a data science model to be utilized by an entity to decide whether or not to extend a particular type of service (e.g., a loan, a credit card account, a bank account, or the like) to a respective individual within a population. In this respect, the set of formal parameters for the model object may comprise data variables that are predictive of whether or not the entity should extend the particular type of service to a respective individual (e.g., variables that provide information related to credit score, credit history, loan history, work history, income, debt, assets, etc.), and the score may indicate a likelihood that the entity should extend the particular type of service to the respective individual, which may then be compared to a threshold value in order to reach a decision of whether or not to extend the particular type of service to the respective individual.

The function of training the model object may also take any of various forms, and in at least some implementations, may involve applying a machine-learning process to a training dataset that is relevant to the particular type of decision to be rendered by the data science model (e.g., a set of historical data records for individuals that are each labeled with an indicator of whether or not a favorable decision should be rendered based on the historical data record). In this respect, the machine-learning process may comprise any of various machine learning techniques, examples of which may include regression techniques, decision-tree techniques, support vector machine (SVM) techniques, Bayesian techniques, ensemble techniques, gradient descent techniques, and/or neural-network techniques, among various other possibilities.

As shown in FIG. 3B, the example process 300 may begin at block 302 upon receiving a request to compute a score for an input data record. The input data record may comprise a group of actual parameters that map to a set of features that a trained data science model (e.g., the model object) is configured to receive as input.

As shown in block 304, the example process 300 further includes inputting the group of actual parameters into the trained data science model. The trained data science model comprises an ensemble of decision trees wherein each individual decision tree in the ensemble is symmetric, each individual decision tree in the ensemble is configured to receive a respective subset of the features as input, and, within each individual decision tree, internal nodes that are positioned in a same level designate a same splitting criterion based on a same feature selected from the respective subset of features. The trained data science model may be, for example, a categorical boosting (CatBoost) model.

As shown in block 306, the example process 300 further includes, for each individual decision tree in the ensemble, identifying a respective leaf such that the actual parameters satisfy a series of splitting conditions for edges that connect nodes in a respective path from a root of the individual decision tree to the respective leaf, and accessing a set of respective individual contribution values (e.g., via retrieval from a storage location in a computer-readable medium) for the respective leaf. (In this example, the set of respective individual contribution values was precomputed and stored beforehand via a process such as the example process 301 shown in FIG. 3A.) Each of the respective individual contribution values maps to a respective feature found in the respective subset of features. The respective individual contribution values and the respective overall contribution values may be, for example, Shapley values, Owen values, or Banzhaf-Owen values.

In one example, determining the set of respective individual contribution values for the respective leaf comprises a number of actions, such as: identifying each realizable path from the root of the individual decision tree to each realizable leaf in the individual decision tree, respectively; for each identified realizable path, computing a respective first probability by dividing a number of the training data records that were scored during the training based on the identified realizable path by a total number of training data records in the training data; for each identified realizable path, identifying a respective score to be assigned to input data records scored by the identified realizable path; for each level of the individual decision tree, identifying the same feature on which the same splitting criterion specified by the internal nodes at that level is based; identifying subsets of the respective subset of features that the individual decision tree is configured to receive as input; for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree; for each identified subset of the respective subset of features, computing a sum of the respective first probabilities for each realizable path in the identified subset; and for each identified subset of the respective subset of features, computing a marginal path expectation by multiplying the respective score for the respective path by the sum for the identified subset. This same set of actions can be applied to each leaf in the ensemble. The sets of contribution values generated thereby may be used to populate a data structure with entries that map the leaves in the ensemble of decision trees to the respective sets of contribution values.

The action of identifying each realizable path from the root of the individual decision tree to each realizable leaf in the individual decision tree, respectively, may involve identifying a selected path to be evaluated for realizability; detecting that a first splitting condition for a first edge in the selected path and a second splitting condition for a second edge in the path contradict each other; and excluding the selected path from a list of realizable paths.

In some examples, the set of respective individual contribution values for the respective leaf may have been computed beforehand and stored in a data structure that maps leaves to respective sets of contribution values. In such examples, determining the set of respective individual contribution values for the respective leaf may involve: receiving an identifier of a leaf selected from a decision tree in the ensemble; and, based on the identifier of the leaf, determining a set of contribution values to which the identifier maps in the data structure. (The determined set of contribution values to which the identifier maps in the data structure is the set of respective individual contribution values.)

As shown in block 308, the example process 300 further includes, for each individual feature in the set of features, computing a respective overall contribution value based on a sum of the respective individual contribution values that map to that individual feature. This may be achieved, for example, by summing the local contribution values for each tree in the ensemble for the individual feature.

As shown in block 310, the example process 300 further includes computing, via the trained data science model, the score for the input data record based on the respective leaves identified.

The example process may further include identifying at least one reason code for the score based on the respective overall contribution values for the individual features in the set of features. Still further, the example process 300 may include transmitting the score and the at least one reason code in response to the request.

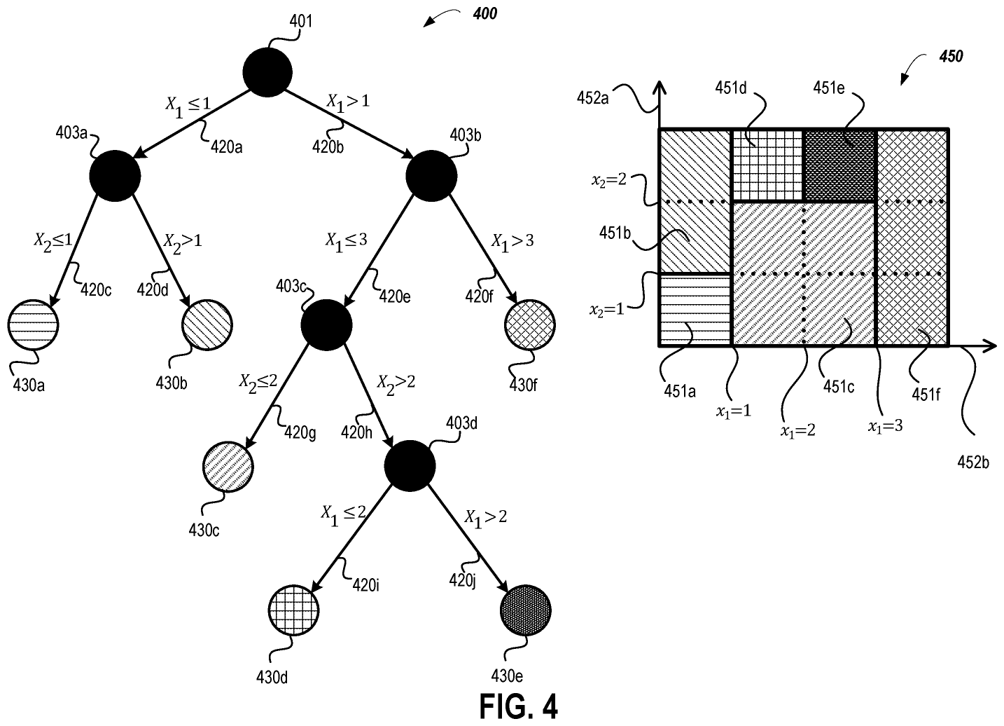

Turning to FIG. 4, a decision tree 400 is shown that will be referred to in the following examples. FIG. 4 also depicts a grid 450 that illustrates regions that map to the leaves 430a-f of the decision tree 400, according to one example. The inequalities that are shown adjacent to the edges 420a-j of the decision tree 400 represent splitting conditions that will determine the path from the root 401 of the decision tree 400 to one of the leaves 430a-f of the decision tree 400 based on a group of actual parameters included in a given input data record.

As will be recognized by persons of ordinary skill in the art, formal parameters refer to variables that act as placeholders within the definition of a function, a subroutine, a procedure (e.g., in procedural programming languages), or any module of code that (i) has its own local variable scope and (ii) can receive, through a parameter list supplied when the module (e.g., function) is called, values (e.g., actual parameters, which are sometimes called “arguments”) to be used in place of the placeholder variables (e.g., formal parameters) declared in the module definition during execution of the module with the supplied parameter list.

A decision tree is one example of a function in that a decision tree (1) receives values, (2) compares those values to a series of splitting conditions for edges (e.g., arcs or directed edges) that connect nodes in the tree to identify a path from the root node of the tree to a leaf of the tree such that those values satisfy the splitting conditions for edges that connect nodes in a path from the root to a leaf, and (3) returns a label (e.g., a score) associated with the leaf.

As will be recognized by persons of ordinary skill in the art, a decision tree can be represented by a connected acyclic graph in which each node (i.e., vertex) other than the root is the head or target (i.e., terminal vertex) of a single directed edge and each internal node (i.e., a node that is not a leaf node) is the tail (i.e., initial vertex) of at least one directed edge. (In the case of a binary tree, each internal node is the initial vertex of at least one directed edge and no more than two directed edges.) Each directed edge connects a node from an n^{th} level of the tree to a node in the (n+1)^{th} level in the tree, where n is a non-negative integer. (For reference, in accordance with nomenclature conventions known to those of skill in the art, the root of a decision tree is considered to be positioned in the first level of that decision tree.) The root of a decision tree is a source (i.e., a node with an in-degree of zero); each leaf in a decision tree is a sink (i.e., a node with an out-degree of zero).

With regard to nomenclature for binary trees that will be familiar to those of skill in the art, the decision tree 400 is a “full” binary tree because each node in the decision tree 400 is an initial vertex of zero or two edges. As will be recognized by those of skill in the art, the “depth” of a given node is the number of edges in the path from the root node to the given node (thus, the depth of a root node is zero). The height of a binary tree is the depth of the leaf in the binary node that is farthest from the root node. The decision tree 400 is not “balanced” because the height of the left subtree of the root 401 differs from the height of the right subtree of the root 401 by more than one level. Furthermore, the decision tree 400 is not “complete” because some levels of the decision tree 400 other than the last level (which is the fifth level in this example) are not filled. Also, the decision tree 400 is not a “perfect” binary tree. A “perfect” binary tree is a special type of binary tree in which each leaf is at the same level (i.e., depth), and each internal node has two children. However, as shown in FIG. 4, some of the leaves 430a-f are positioned in different levels (although each of the internal nodes 403a-d is an initial vertex of two directed edges).

For the purposes of FIG. 4, the group of actual parameters will be denoted as (x₁, x₂). The formal parameters (e.g., features) that the decision tree 400 is configured to receive as input will be denoted by (X₁, X₂). Each of the actual parameters (x₁, x₂) maps, respectively, to the formal parameter that has a matching subscript. This is consistent with convention in many programming languages (i.e., actual parameters provided in an ordered list during a function call are presumed to map to the formal parameters that are in the same positions, respectively, in the ordered list of parameters in the function definition). Thus, in this example, x₁ maps to X₁. Similarly, x₂ maps to X₂. While the decision tree 400 is configured to receive two parameters as input for the sake of simplicity in this example, persons of skill in the art will recognize that decision trees may be configured to receive more than two parameters as input (e.g., dozens of parameters).

Since the decision tree 400 is configured to receive two formal parameters as input, the decision tree 400 is a function of two variables. The domain (i.e., the set of possible input values for which the function is defined) of the decision tree 400 can, therefore, be represented intuitively in two dimensions by the grid 450. The range (i.e., set of possible output values that the function can output) of the decision tree 400 is indicated by the regions 451a-f into which the grid 450 is divided.

The vertical axis 452a depicts a set of potential values ranging from zero to three that the actual parameter x₂ may specify for the formal parameter X₂. Similarly, the horizontal axis 452b depicts a set of potential values from zero to four that the actual parameter x₁ may specify for the formal parameter X₁. Note, however, that these sets of potential values have not been selected for this example to imply that any upper bounds or lower bounds exist on the possible values that may be specified for the formal parameters (X₁, X₂); the output for the decision tree 400 is still defined for (i) values of x₁ that are less than zero or greater than four and for (ii) values of x₂ that are less than zero or greater than three. Rather, these sets of potential values have been selected for illustrative purposes so that the portion of the domain of the decision tree 400 depicted by the grid 450 is large enough to include a region of the tree that maps to each of the leaves 430a-f, respectively. Each of the regions 451a-f maps to a respective one of the leaves 430a-f (as indicated by the respectively matching fill patterns of 451a-f and 430a-f) for reasons that will be explained in greater detail below.

Consider, for example, the region 451a. The region 451a represents cases in which x₁ is a value between zero and one, inclusive, and x₂ is also a value between zero and one, inclusive. If the decision tree 400 is evaluated against a set of actual parameters (X₁, X₂) that satisfy these constraints, the decision tree 400 will return the score that is associated with the leaf 430a. This can be verified in this example by beginning at the root 401 of the decision tree 400 and comparing the actual parameters (x₁, x₂) to the splitting criterion for the root 401. The splitting criterion for the root 401 is expressed by the splitting conditions for the edges 420a-b because these are the two edges for which the root 401 is the initial vertex. In this example, the splitting criterion for the root 401 designates a threshold (the number one, in this case).

As shown, the splitting conditions for the edges 420a-b are mutually antithetical. In other words, if the splitting condition for the edge 420a (i.e., X₁≤1) is satisfied, the splitting condition for the edge 420b (i.e., X₁>1) is not satisfied. Conversely, if the splitting condition for the edge 420b is satisfied, the splitting condition for the edge 420a is not satisfied. Stated more generally, in this example, the splitting condition for the edge 420a is that X₁ does not exceed the threshold designated by the splitting criterion for the root 401 and the splitting condition for the edge 420b is that X₁ exceeds the threshold. In this example, since the actual parameter x₁ (which maps to the formal parameter X₁) is a value selected from the region 451a, x₁ is less than or equal to one. The path through the decision tree 400 therefore proceeds from the root 401 (which is positioned in the first level of the decision tree 400) to the internal node 403a (which is positioned in the second level of the decision tree 400) via the edge 420a.

Next, the actual parameters (x₁, x₂) are compared to the splitting criterion for the internal node 403a. The splitting criterion for the internal node 403a is expressed by the splitting conditions for the edges 420c-d because these are the two edges for which the internal node 403a is the initial vertex. Since the actual parameter x₂ (which maps to the formal parameter X₂) is a value selected from the region 451a, x₂ is less than or equal to one. Therefore, the splitting condition for the edge 420c (i.e., X₂≤1) is satisfied and the splitting condition for the edge 420d (i.e., X₂>1) is not satisfied. As a result, the path through the decision tree 400 proceeds from the internal node 403a (which is positioned at the second level of the decision tree 400) to the leaf 430a (which is positioned in the third level of the decision tree 400) via the edge 420c. The score associated with leaf 430a will therefore be returned when the decision tree 400 is evaluated against a set of actual parameters selected from the region 451a. For this reason, the region 451a is said to map to the leaf 430a. In other words, when the decision tree 400 is evaluated against a set of actual parameters selected from the region 451a, an input data record that comprises this set of actual parameters will “land in” the leaf 430a.

A similar walkthrough can be done for sets of actual parameters selected from each of the regions 451b-e to verify that the region 451b maps to the leaf 430b, the region 451c maps to the leaf 430c, the region 451c maps to the leaf 430c, the region 451d maps to the leaf 430d, the region 451e maps to the leaf 430e, and the region 451f maps to the leaf 430f.

The relationship between the grid 450 and the leaves 430a-f as described above has at least two implications. First, two input data records whose actual parameters are selected from a same region in the grid 450 will “land in” the same leaf-namely, the leaf to which that region maps- and will both be assigned the score associated with that leaf. Second, each threshold designated by a splitting criterion for a node in the decision tree 400 will mark a border between at least two regions in the grid 450 along the dimension (e.g., formal parameter) to which the threshold applies. For example, the splitting criterion for the root 401 designates the number one as a threshold for X₁. As shown in the grid 450, the number one along the horizontal axis (which represents the set of potential values for X₁) marks a solid vertical line that separates the region 451a from the region 451c, the region 451b from the region 451c, and the region 451b from the region 451d. This vertical border, which is established by a splitting criterion that applies to X₁, extends across the full height of the grid 450. In other words, regardless of the value selected for X₂, the line x₁=1 marks a border between regions. Thus, the status of the solid vertical line x₁=1 as a border is independent of the value selected for X₂. For similar reasons, the solid vertical line x₁=3 marks a vertical border across the full height of the grid 450 regardless of the value selected for X₂.

By contrast, the splitting criterion for the internal node 403a designates the number one as a threshold for X₂. As shown in the grid 450, the number one along the vertical axis (which represents the set of potential values for X₂) marks a horizontal border that separates the region 451a from the region 451b. However, unlike the solid vertical line x₁=1, the solid portion of the horizontal line at x₂=1 does not extend across the full width of the grid 450. Specifically, for values of X₁ greater than one, the dashed portion of the horizontal line x₂=1 does not mark a border between regions. Thus, the status of the horizontal line x₂=1 as a border (i.e., whether it is a solid line or a dashed line) is not independent of the value selected for X₁. Similarly, the horizontal line x₂=2 and the vertical line x₁=2 mark borders that do not fully traverse the grid 450.

This dependence relationship between (i) the status of a threshold designated by a splitting criterion found in the decision tree 400 as a border along the dimension to which the threshold applies and (ii) the value selected for a formal parameter to which the threshold does not apply results from certain structural characteristics of the decision tree 400. First, the leaves 430a-f are distributed across more than one level of the decision tree 400. For example, leaf 430a, leaf 430b, and leaf 430f are positioned in the third level, while leaf 430c is positioned in the fourth level, and leaves 430d-e are positioned in the fourth level of the decision tree 400. Second, although the internal node 403a and the internal node 403b are both positioned in the second level of the decision tree 400, the splitting criterion for the internal node 403a and the splitting criterion for the internal node 403b apply to different formal parameters (X₂ and X₁, respectively). Third, the splitting criterion for the internal node 403a and the splitting criterion for the internal node 403b designate different thresholds (one and three, respectively).

If the decision tree 400 is intended to be used to compute scores alone, the structural characteristics of the decision tree 400 that result in the dependence mentioned above might be of little concern. However, if contribution values for the parameters used by the decision tree 400 are desired in addition to the score that the decision tree 400 computes for an input data record, these structural characteristics pose a problem.

To illustrate this problem, consider the following example. Suppose a first input data record includes actual parameters selected from the region 451c shown in the grid 450. Specifically, suppose that the actual parameter x₁ is greater than one, but less than or equal to two. Also suppose that the actual parameter x₂ is greater than one, but less than or equal to two. Since the region 451c maps to the leaf 430c, the decision tree 400 will return the score associated with the leaf 430c for the first input data record.

Further suppose that a second input data record also includes actual parameters selected from the region 451c. However, for the second input data record, suppose that the actual parameter X₁ is greater than two, but less than three. In addition, for the second input data record, suppose that x₂ is greater than or equal to zero, but less than one. Again, since the region 451c maps to the leaf 430c, the decision tree 400 will return the score associated with the leaf 430c for the second input data record.

Although the first input data record and the second input data record both land in the leaf 430c, they map to subregions of the region 451c (e.g., as shown by the dashed lines that cross the region 451c) that would have been divided by a solid vertical border (marked by the line x₁=1) and by a horizontal border (marked by the line x₂=1) but for the dependence relationship explained above. In cases where two input data records (i) land in the same leaf of a decision tree, yet (ii) map to different subregions of a grid region that maps to the leaf, as discussed above, the contribution values (e.g., game values such as Shapley values and Owen values) for the formal parameters used by the tree will generally not be equal for the two input data records. In other words, although the two input data records land in the same leaf and will be assigned the same score by the decision tree, the two input data records will not have the same contribution values for their respective features. A formal proof of this principle has been provided in Filom et al., “On marginal feature attributions of tree-based models,” ArXiv, arxiv: 2302.08434v2(2023), which is hereby incorporated by reference in its entirety.

Thus, the structural characteristics of the decision tree 400 that result in the dependence relationship explained above render the decision tree 400 insufficient for determining contribution values without additional extrinsic data (e.g., training data) that is not incorporated into the decision tree 400 itself. The methods available for determining contribution values for the decision tree 400 are computationally intensive and have certain drawbacks for some applications that involve determining contribution values for large numbers of input data records.

Filom et al. (cited above) have demonstrated that the type of problematic dependence relationship described above can be eliminated if several specific constraints, discussed in further detail below, on the structural characteristics of a decision tree are satisfied. Filom et al. (cited above) have further demonstrated that the contribution values will be equivalent for each input data record that lands in the same leaf of a decision tree that satisfies these constraints.

Thus, each leaf in a decision tree that satisfies these constraints (e.g., the decision tree is symmetric) maps to a single respective set of contribution values for the formal parameters (e.g., features) the decision tree is configured to receive as input. As a result, sets of contribution values for features can be determined on a leaf-by-leaf basis rather than on an input-data-record-by-input-data-record basis. Effectively, once the set of contribution values for the features for a single input data record that lands in a leaf is known, the set of contribution values for the features for each other input data record that lands in that leaf is also known. This unexpected principle can be leveraged by storing each computed set of contribution values into a data structure that maps leaves to sets of contribution values (e.g., a lookup table or a hash table). Once the set of contribution values to which a leaf maps has been computed and stored in the data structure, the set of contribution values for an input data record that subsequently lands in the leaf can be retrieved via a rapid lookup operation rather than through an arduous series of calculations.

The speed at which a set of contribution values can be retrieved subsequent to computation is not the only way efficiency can be increased, however. Filom (cited above) have also demonstrated that when the problematic dependence relationships described above with respect to FIG. 4 are eliminated, the general formula for determining marginal Shapley values can be simplified such that the computational complexity for determining marginal Shapley values is greatly reduced. Furthermore, the simplified version of the formula does not call for data extrinsic to the decision tree itself (e.g., the training dataset used to train the decision tree or a background data set). Thus, the efficiency of both processor usage (because the complexity reduced) and memory usage (because extrinsic data does not have to be stored or retrieved) can be increased at the computation stage for sets of contribution values as well as the retrieval stage.

The increases in efficiency at the computation stage are such that, in many cases, the sets of contribution values to which the leaves of a decision tree map can be exhaustively calculated before the decision tree is deployed for use so that both scores and contribution values can be returned rapidly for input data records immediately upon deployment of the decision tree. Nevertheless, if an exhaustive determination of the sets of contribution values to which the leaves map is prohibitively costly (e.g., in terms of memory, processor capacity, or other computing resources) or otherwise not desirable prior to deployment, the data structure for retrieval can be populated piecemeal over time (e.g., each time an input data record lands in a leaf in which no previous input data record has landed, the set of contribution values can be computed and an entry that maps the leaf to the set of contribution values can be added to the data structure).

In light of the advantages described above, it will be illustrative to provide an example in which the specific constraints on the structural characteristics of a decision tree are satisfied such that these advantages can be obtained.

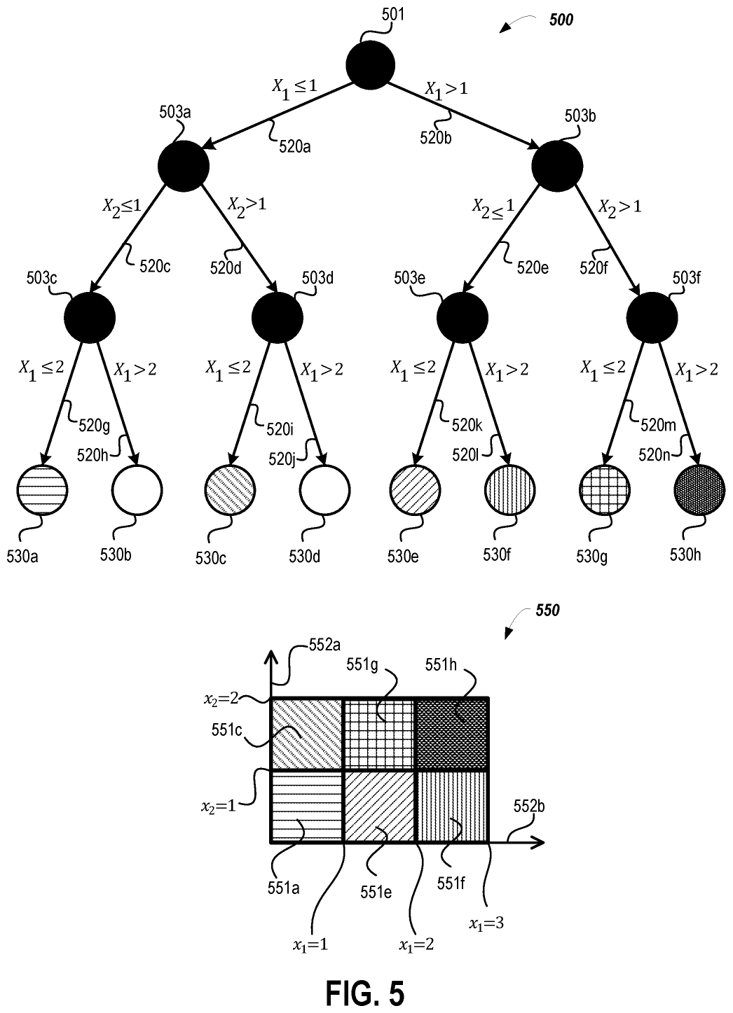

Turning to FIG. 5, a decision tree 500 is depicted along with a grid 550 that illustrates regions that map to the leaves 530a-f of the decision tree 500, according to one example. The inequalities that are shown adjacent to the edges 520a-n of the decision tree 500 represent splitting conditions that will determine the path from the root 501 of the decision tree 500 to one of the leaves 530a-f of the decision tree 500 based on a group of actual parameters included in a given input data record.

With regard to the nomenclature for binary trees that is familiar to those of skill in the art, the decision tree 500 is a “full” binary tree because each node in the decision tree 500 is an initial vertex of zero or two edges. The decision tree 500 is also “balanced” because the height of the left and right subtrees of the root 501 (and the respective left and right subtrees of each of the internal nodes 503a-f) are equivalent. Furthermore, the decision tree 500 is also “complete” because each level of the decision tree 500 is filled. Ultimately, the decision tree 500 is a “perfect” binary tree because the leaves 530a-h are positioned in the same level and each of the internal nodes 503a-f is an initial vertex of two directed edges.

For the purposes of FIG. 5, the group of actual parameters will be denoted as (x₁, x₂) (as was the case for FIG. 4). The formal parameters (e.g., features) that the decision tree 500 is configured to receive as input will be denoted by (X₁, X₂). Each of the actual parameters (x₁, x₂) maps, respectively, to the formal parameter that has a matching subscript.

Like the decision tree 400 shown in FIG. 4, the decision tree 500 is configured to receive two formal parameters as input. The domain of the decision tree 500 is represented in two dimensions by the grid 550. The range of the decision tree 500 is indicated by the regions 551a-f into which the grid 550 is divided.

The vertical axis 552a depicts a set of potential values ranging from zero to two that the actual parameter x₂ may specify for the formal parameter X₂. Similarly, the horizontal axis 552b depicts a set of potential values from zero to three that the actual parameter x₁ may specify for the formal parameter X₁. Note that these sets of potential values do not imply that any upper bounds or lower bounds exist on the possible values that may be specified for the formal parameters (X₁, X₂).

The structural characteristics of the decision tree 500 satisfy the constraints mentioned above such that the advantages mentioned above can be achieved. These constraints will be described in turn. First, within any given level of the decision tree 500, each internal node in the given level specifies the same splitting criterion (e.g., designates the same threshold and applies to the same feature) as the other internal nodes in the given level. For example, in the second level of the decision tree 500, the internal node 503a and the internal node 503b both specify the splitting criterion X₂≤1. In the third level of the decision tree 500, the internal node 503c, the internal node 503d, the internal node 503e, and the internal node 503f each specify the splitting criterion X₁≤2. The fourth level is the last level of the decision tree 500 and contains the leaves 530a-f; there are no internal nodes in the fourth level of the decision tree 500, so there are no criteria to be compared for the fourth level. Of course, there is only one internal node in the first level of the decision tree 500—namely, the root 501—so there are no other nodes in the first level whose criteria can be compared to the criterion specified by the root 501. Since the respective splitting criterion used at each level of the decision tree 500 applies to a single feature, the number of features that the decision tree 500 is configured to receive as input is no greater than the number of levels in the tree. This upper bound on the number of features that may be used by a decision tree of a given depth is helpful for reducing computational complexity. Second, the decision tree 500 is a “perfect” binary tree (i.e., each internal node in the decision tree 500 is an initial vertex of two edges and each leaf in the decision tree 500 is at the same level). Decision trees that satisfy these two constraints are said to be symmetric (i.e., oblivious). Hence, the decision tree 500 is symmetric. Symmetric decision trees provide the potential for an additional advantage that can be leveraged to increase computational speed in combination with the other advantages discussed herein, as discussed below.

As explained above, the splitting criterion specified in each level of a symmetric decision tree is the same for each node in that level. As a result, each level of the symmetric tree (except the last level, which does not include internal nodes) can be mapped to a single respective threshold and a single respective feature to which that threshold applies.

A first vector of the thresholds to which the levels of the symmetric decision tree map can be generated. The numerical position (e.g., index) of a threshold in the first vector indicates the level of the symmetric decision tree to which that threshold applies. A second vector that identifies the formal parameters to which the thresholds in the first vector apply can also be generated. For example, each entry in the second vector can match the subscript of the formal parameter to which the threshold in the corresponding numerical position in the first vector applies.

When an input data record to be scored by the symmetric decision tree is provided, a third vector can be generated. Each entry in the third vector is the actual parameter (selected from the input data record) that maps to the formal parameter in the corresponding numerical position in the second vector. Once the third vector is generated, a fourth vector that represents the path through the symmetric decision tree between a leaf to the root for the input data record can be generated. The entry for each numerical position in the fourth vector may be a binary value that is determined by comparing the entry at that numerical position in the third vector (which is an actual parameter) to the entry at that numerical position in the first vector (which is a threshold). If the entry in the third vector exceeds the entry in the first vector, the entry in the fourth vector is set to one to signify that the path proceeds through a right edge that proceeds out of a node positioned in the level of the symmetric decision tree that matches the numerical position of the entry. Otherwise, the entry is set to zero to signify that the path proceeds through a left edge that proceeds out of the node positioned in the level of the symmetric decision tree that matches the numerical position of the entry.

Since the splitting criterion for a given level of a symmetric decision tree is the same for each node in that level, the threshold to which a comparison is to be made at any given level is independent of the route of the path through the symmetric decision tree in previous levels. Furthermore, the actual parameter to be compared to the threshold is also independent of the route of the path through the symmetric decision tree in previous levels because the formal parameter to which the threshold applies (and to which the actual parameter maps) is independent of the route of the path through the symmetric decision tree in previous levels. As a result of this independence between the respective splitting criterion for each level and the route of the path through previous levels of the symmetric decision tree, the entries for the fourth vector (which represents the path through the symmetric decision tree for the input data record) can be computed in parallel rather than in series. As a result, the speed to compute the leaf in which the input data record lands can be increased.

Returning to the specific example of the decision tree 500, the relationship between the decision tree 500 and the grid 550 is similar to the relationship between the decision tree 400 of FIG. 4 and the grid 450 of FIG. 4. However, unlike the grid 450, the grid 550 has no dotted line to mark any border because the decision tree 500 is symmetric whereas the decision tree 400 is not. In particular, two input data records whose actual parameters are selected from a same region in the grid 550 will “land in” the same leaf-namely, the leaf to which that region maps- and will both be assigned the score associated with that leaf in the decision tree 500.

Note that there are eight leaves (i.e., the leaves 530a-h) in the decision tree 500, but there are six regions in the grid 550. This is because no possible input data record will land in the leaf 530b or in the leaf 530d. The path from the root 501 to the leaf 530b includes both an edge with the splitting condition X₁≤1 and an edge with the splitting condition X₁>2; there is no possible value for X₁ that can satisfy both of these splitting conditions concurrently. Similarly, the path from the root 501 to the leaf 530d includes these contradictory splitting conditions. For this reason, the leaf 530b and the leaf 530d are said to be non-realizable. By contrast, the leaves 530a, c, e-h are said to be realizable because there are combinations of possible values of X₁ and X₂ that can satisfy the splitting conditions in the respective paths from the root to the leaves 530a, c, e-h. The grid 550 includes a region that maps to each realizable leaf, but does not include any regions that map to non-realizable leaves.

Each threshold designated by a splitting criterion for a node in the decision tree 500 (which is also the splitting criterion for the level in which that node is positioned) marks a border between at least two regions in the grid 550 along the dimension (e.g., formal parameter) to which the threshold applies. For example, the splitting criterion for the root 501 designates the number one as a threshold for X₁. As shown in the grid 550, the number one along the horizontal axis (which represents the set of potential values for X₁) marks a solid vertical line that separates the region 551a from the region 551e and the region 551c from the region 551g. This vertical border, which is established by a splitting criterion that applies to X₁, extends across the full height of the grid 550. In other words, regardless of the value selected for X₂, the line x₁=1 marks a border between regions. Thus, the status of the solid vertical line x₁=1 as a border is independent of the value selected for X₂. For similar reasons, the solid vertical line x₁=2 marks a vertical border across the full height of the grid 550 regardless of the value selected for X₂.

Similarly, the splitting criterion for the internal node 503a designates the number one as a threshold for X₂. As shown in the grid 550, the number one along the vertical axis (which represents the set of potential values for X₂) marks a solid horizontal line that separates the region 551a from the region 551c. Unlike the example shown in FIG. 4, the horizontal line x₂=1 traverses the full width of the grid 550, thereby marking a border between (i) 551a and 551c; (ii) 551e and 551g; and (iii) 551f and 551h. Thus, the status of the horizontal line x₂=1 as a border is independent of the value selected for X₁.

Thus, in the example shown in FIG. 5, there is independence between (i) the status of each threshold designated by a splitting criterion found in the decision tree 500 as a border along the dimension to which the threshold applies and (ii) the value selected for a formal parameter to which the threshold does not apply. This independence results because the decision tree 500 is symmetric (i.e., the structural characteristics of the decision tree 500 satisfy the constraints that apply to symmetric trees, as explained above).

With the examples shown in FIGS. 4-5 and the constraints thus explained, it will be helpful to illustrate how the processes described herein may operate in practice by describing the process in detail for an example decision tree.

Turning to FIG. 6, an ensemble 600 of symmetric decision trees is depicted that will be referenced in the explanation below of a process for determining contribution values for features used on the ensemble 600, according to one example.

Suppose the ensemble 600 is a CatBoost model that has been trained against a training dataset. Also suppose that there are a total of M trees in the ensemble 600, where M is a positive integer. Let T₁(X), T₂(X), . . . . Tₘ(X) denote the trees in the ensemble, where X represents the set of formal parameters (e.g., features, which are stored in a vector in this example) that the ensemble 600 is configured to receive as input, and the subscripts represent indices to identify the individual decision trees within the ensemble 600.

The decision tree 601 is shown as an example of an individual tree. The operations below will be described with respect to the decision tree 601 for the sake of simplicity, but those same operations will be performed each decision tree in the ensemble 600 during the process of computing contribution values for the features. Persons of skill in the art will understand that at least some of the operations and other actions described below may be performed in orders other than the order provided in this example.

The process may commence by identifying the realizable paths through the decision tree 601 and storing a collective representation of those paths in a matrix. A single path through the tree may be represented by a vector of binary values. In one example, suppose there are n levels in the decision tree 601, where the root 602 is in the first level and the leaves of the decision tree 601 are in the n^{th} level. In this example, the numerical position (e.g., index) of an entry in the vector may be defined as n minus the level of the decision tree 601 to which the entry maps. An entry with a binary value of one at an index j in the vector signifies that the path represented by the vector includes a right edge that points to a node positioned in the (n−j)^{th} level of the decision tree 601. In contrast, an entry with a binary value of zero at the index j in the vector signifies that the path represented by the vector includes a left edge that points to the node positioned in the (n−j)^{th} level of the decision tree 601. Since other vectors described below will also include binary values, a vector that represents a path will be called a path vector. (For example, given a path a, the example equation a=(1,0,0,1,0) would indicate that the path vector (1,0,0,1,0) represents the path a through a binary tree of depth 5.) Each path vector for a realizable path through the decision tree 601 is stored as a row of a matrix of paths that will be called the path matrix.

Next, a probability estimate is determined for each realizable leaf in the decision tree 601. Let Rₐ denote the realizable leaf that is connected to the root 602 of the decision tree 601 by the path a. The probability [symbol] for the realizable leaf Rₐ (and therefore the probability assigned to the path a) can be estimated (the estimate is represented by [symbol] ) by dividing the number of training instances (e.g., input data records used for training, which may be) in the training dataset that landed in the realizable leaf during training of the decision tree 601 by the number of training instances in the training dataset, as indicated by the equation below:

$$ℙ ( X ∈ {R}_{a} ) \approx \frac{number of training instances that landed in {R}_{a}}{number of training instances in the training set} = \hat{ℙ} ( X ∈ {R}_{a} ) ,$$

where X∈Rₐ denotes the proposition that a set of actual parameters that map to the features in the vector X lands in the realizable leaf Rₐ.

Given that the ensemble 600 is a CatBoost model in this example, one characteristic of the decision tree 601 and the other member trees of the ensemble 600 is that each member tree is configured to use a (usually small) subset of the features that the ensemble 600 is configured to receive as input. Suppose there are n features that the ensemble 600 is configured to receive as input, where n is a positive integer. Also suppose that N denotes the set of the features that the ensemble 600 is configured to receive as input. In other words, N is the set of global features for the ensemble 600. The cardinality (i.e., number of elements in a set) of N is denoted by |N| and is equal to n. Further suppose that K denotes the set of features on which the decision tree 601 splits and that k denotes the number of features in K (which can also be represented by |K|, which is the cardinality of K). K is therefore a subset of N; k is a positive integer that is less than or equal to n. K constitutes the set of local features for the decision tree 601. The case k=n would rarely be implemented in practice because it would be likely to cause overfitting. (Note that k is not allowed to exceed the depth of the tree; in practice, it may be preferable to constrain the depth of the tree to no more than fifteen.) For that reason, suppose that k<n (i.e., K is a proper subset of N) for the purposes of this example.

The features in K were selected (e.g., randomly or by an optimization mechanism applied during training) from N. As a result, the indices that map to the features in a vector that stores the elements of K (i.e., the local features for the decision tree 601) typically will not match the indices of those same features in a vector that stores the elements of N (i.e., the global features for the ensemble 600). As will be shown further below, it is useful to create local-to-global mapping that maps the indices of local features in the vector that stores K to the indices of those same features in the vector that stores N. The local-to-global mapping can be stored in a data structure such as a lookup table.

Next, for each feature i in K, the set of the levels of the decision tree 601 for which i is the feature to which the splitting criterion for the level applies is identified. In other words, if the splitting criterion for a level of the decision tree 601 applies to i, that level is included in the set of levels for i. The set of levels for i is denoted by [symbol] (i). The set of levels [symbol] (i) may be stored by a vector that contains the indices of the elements of [symbol] (i) (e.g., the depths of the levels in [symbol] (i)) in the decision tree 601. The set of the sets [symbol] (i) for each feature i in K is denoted by [symbol] . For reference, Filom et al. (cited above) refer to levels as “partitions” and also uses [symbol] (i) and [symbol] to represent the set of levels for i and the set of sets of levels of i, respectively.

In this example, suppose the contribution values to be determined are Shapley values. The generalized formula for computing Shapley values is given by

$${ϕ}_{i} [ {v}^{ME} , N ] = {\sum }_{S ⊆ N \backslash \{ i \}} w ( s , n ) ( {v}^{ME} ( S ⋃ \{ i \} ) - {v}^{ME} ( S ) ) , S ⊆ N ,$$

where ϕᵢ[v^{ME}, N] represents the Shapley value for the feature i, S represents a proper subset of N that does not include the feature i, s represents the number of elements in S (i.e., the cardinality of S), w(s, n) represents a known weight value, {i} represents the set of features containing i alone and no other elements, and v^{ME}(S∪{i}), where dependence on parameters (x, X, f) is suppressed as indicated above, represents a game based on marginal expected values of the decision tree 601. In this context, the term “game” refers to a game as defined in game theory, as will be recognized by persons of skill in the art. In the game v^{ME}, the features in N are considered to be the players (as defined in game theory); the payoffs and rules (as defined in game theory) are established by the structure of the decision tree 601.

In this example, it will be useful to provide notations for some additional quantities that will be computed during the process of determining Shapley values for the leaves in the decision tree 601. Let b denote a path. As noted above, a also denotes a path. For the pair of path a and path b, which is denoted by (a, b), it will be helpful to identify a subset of the set of features K that highlights similarities between how the feature i influences path a and how the feature i influences path b. Specifically, it will be helpful to know at which levels path a and path b have matching path directions. In this context, there are two scenarios in which path a and path b are considered to have a matching path direction at a given level of the decision tree 601. In the first scenario, (i) path a proceeds to the next level in the decision tree 601 through a left edge of the node through which path a passes in the given level and (ii) path b proceeds to the next level in the decision tree 601 through a left edge of the node through which path b passes in the given level. In the second scenario, (i) path a proceeds to the next level in the decision tree 601 through a right edge of the node through which path a passes in the given level and (ii) path b proceeds to the next level in the decision tree 601 through a right edge of the node through which path b passes in the given level.

In other words, in the first scenario, both path a and path b proceed to a left subtree of a node in the given level. Path a and path b may or may not pass through the same node of the given level to the same subtree, but path a and path b are considered to have a matching path direction in either case as long as they both proceed via a left edge for which a node in the current level is the initial vertex. Similarly, in the second scenario, both path a and path b proceed to a right subtree of a node in the given level. Path a and path b may or may not pass through the same node of the given level to the same subtree, but path a and path b are considered to have a matching path direction in either case as long as they both proceed via a right edge for which a node in the current level is the initial vertex.

With the meaning of the phrase “matching path directions” thus explained, a subset of levels that reflects commonalities between how the features in K influence two paths is defined in the equation below:

$$ε ( a , b ) := \{ j ∈ K : = \} ,$$

where j denotes a feature in K, [symbol] denotes the splitting directions of the path b at levels of the decision tree 600 that map to respective splitting criteria that apply to the feature j, [symbol] denotes the splitting directions of the path a at levels of the decision tree 600 that map to respective splitting criteria that apply to the feature j, and ε(a, b) denotes the set of pairs of paths for which path a and path b have matching path directions at each level that map to a splitting criterion that applies to the feature j. Note that ε(a, b) will be the empty set if there is no feature j in K for which path a and path b have matching path directions. Also note that ε(a, b) will be equivalent to K if path a equals path b. Of course, depending on which paths are selected as path a and path b, the number of features in ε(a, b) can also be greater than zero or less than the number of features in K.

It will be also be helpful to define an additional set of pairs of paths according to the following equation:

$$C ( a , Z , W ) = \{ ( b , u ) : ε ( a , b ) = W , ε ( b , u ) = \tilde{Z} \} , Z ⊆ W ,$$

where W denotes a subset of K (i.e., the set of local features for the decision tree 601), Z denotes a subset of W, \tilde{Z} denotes the set of features that are in K but are not in Z, u denotes a path, (b, u) denotes a pair of paths, and C (a, Z, W) denotes the set of pairs of paths that conform to the definition established by the equation above (which specifies that (i) the set of pairs of paths ε(a, b) is W; and (ii) the set of pairs of paths ε(b, u) is \tilde{Z}).

Given the equations and definitions provided above, and as explained in greater detail by Filom et al. (cited above), the generalized formula for computing a Shapley value can be reduced to a formula designed specifically to compute the Shapley value for a feature i for a leaf a in the decision tree 601, as shown in the equation below:

$${ϕ}_{i} ( a ) = ( {\sum }_{W ⊆ K} {\sum }_{Z ⊆ W , Z ∋ i} {w}_{+} ( w , z ) {\sum }_{( b , u ) ∈ C ( a , W , Z )} {c}_{b} {p}_{u} ) - ( {\sum }_{i ∉ W} {\sum }_{Z ⊆ W} {w}_{-} ( w , z ) {\sum }_{( b , u ) ∈ C ( a , W , Z )} {c}_{b} {p}_{u} ) ,$$

where w₊(w, z) denotes a weight that is a functional of the weight w(s, n) (defined above) and is known when w(s, n) is known, w₋(w, z) also denotes a weight that is a functional of the weight w(s, n) (defined above) and is known when w(s, n) is known, z denotes the number of features in Z (i.e., the cardinality of Z), c_{b} denotes the value associated with the leaf R_{b} in the decision tree 601 (i.e., the value the decision tree 601 will assign to an input data record that lands in the leaf R_{b}), pᵤ denotes the probability estimate [symbol] (X∈Rᵤ) for Rᵤ, and ϕᵢ(a) denotes the Shapley value for the feature i for the leaf a in the decision tree 601.

The formula ϕᵢ(a) reduces the computational complexity of determining a Shapley value for a feature i for a leaf a in the decision tree 601 to such an extent that it may be practical and desirable to compute the set of Shapley values for the features N of the ensemble 600 for each leaf that is found in the member trees of the ensemble 600. One advantage that results from computing the Shapley values beforehand in this manner is that the Shapley values can be stored in a data structure that maps leaves to their corresponding sets of Shapley values. Once the data structure is populated, the sets of Shapley values for an input data record can be retrieved rapidly from the data structure based on the leaves in which the input data record lands in the decision trees found in the ensemble 600. The overall Shapley value for a feature for the ensemble 600 can be computed by summing the Shapley values for that feature for the decision trees found in the ensemble 600.

To evaluate the formula for ϕᵢ(a) for a given path a (and the leaf indicated thereby) and a given feature i, it will be useful to identify a set of paths referred to herein as a preimage for the path a. The preimage for the path a and a subset of K is defined in the equation below:

$$𝒫 ( a , W ) = \{ b : ε ( a , b ) = W \} ,$$

where a denotes the path, b denotes a path such that the condition ε(a, b)=W is satisfied, W denotes a subset of K (i.e., the set of local features for the decision tree 601), and ε(a, b) denotes a subset of features as explained above. The preimages for the path a and each possible value of W are computed and stored (e.g., in a matrix of preimages for the path a). If sets of contribution values for features are to be precomputed for storage in a data structure for subsequent lookup, the preimages for each path from the root to a leaf of the decision tree 601 paired with each possible value of W (i.e., each possible combination of a and W) can be computed and stored. Notably, the number of elements in the preimage [symbol] (a, W) for the path a is independent of a. Rather, the number of elements in the preimage [symbol] (a, W) is dependent only on W.

Moreover, for every fixed realizable path a, the collection of preimages { [symbol] (a, W)}_{W⊆K} partitions the set of all realizable paths into disjoint parts. Thus, for every fixed realizable path a

$${\sum }_{W ⊆ K} \vert 𝒫 ( a , W ) \vert = ℒ ,$$

where [symbol] is the number of realizable paths. Thus, the preimages for the possible values of W and every path a can be stored together in a matrix of size [symbol] times [symbol] .

Once the preimages have been computed, it will be useful to compute probabilities for the preimages (i.e., the preimage probabilities). The probability of a preimage is defined by the equation below:

$${p}_{pre} ( a , W ) = ℙ ( X ∈ {⋃}_{b ∈ 𝒫 ( a , W )} {R}_{b} ) = {\sum }_{b ∈ 𝒫 ( a , W )} {p}_{b} ,$$

where pₚᵣₑ(a, W) denotes the probability of the preimage [symbol] (a, W), [symbol] denotes a probability estimate (as defined above), R_{b} denotes the realizable leaf that is connected to the root 602 of the decision tree 601 via the path b, p_{b} denotes the probability estimate for R_{b}, and [symbol] R_{b} denotes a set (e.g., a union set) that includes each leaf that is connected to the root 602 via a path that is in the preimage [symbol] (a, W). As shown, the preimage probability is ultimately the sum of the probability estimates for the paths included in the preimage.

Once the preimage probabilities have been computed, marginal path expectations can be computed. The marginal path expectation for the path a and the set of features W is defined by the equation below:

$$mp ( a , W ) = {( {c}_{a} \cdot {{p}_{pre} ( a , W )}^{T} )}^{T} ,$$

where mp(a, W) denotes a marginal path expectation, ca denotes the score associated with the leaf a (i.e., the score that the decision tree 601 will assign to an input data record that lands in the leaf R_{b}), and the use of T in superscript denotes transposing the operand that immediately precedes T (which presumes that the preimage probabilities pₚᵣₑ(a, W) are stored as a vector).

A marginal path expectation can be interpreted as an updated expected value for the leaf Rₐ that is computed by using the probability of the preimage in place of the probability estimate for the leaf Rₐ. Functionally, the process of computing a marginal path expectation can be described as identifying the hyperplanes in the multidimensional space of the domain that bound the region of the domain that maps to the leaf Rₐ.

With the marginal path expectations thus defined, for a given feature i and a given path a, the simplified formula for computing Shapley values can be rewritten as shown in the equation below:

$${ϕ}_{i} ( a ) = ( {\sum }_{W ⊆ K} {\sum }_{Z ⊆ W , Z ∋ i} {w}_{+} ( w , z ) ( {\sum }_{b ∈ 𝒫 ( a , W )} mp ( b , \tilde{Z} ) ) ) - ( {\sum }_{i ∉ W} {\sum }_{Z ⊆ W} {w}_{-} ( w , z ) ( {\sum }_{b ∈ 𝒫 ( W , a )} mp ( b , \tilde{Z} ) ) ) ,$$

where w₊(w, z) denotes a weight that is a functional of the weight w(s, n) (defined above) and is known when w(s, n) is known, w₋(w, z) also denotes a weight that is a functional of the weight w(s, n) (defined above) and is known when w(s, n) is known, z denotes the number of features in Z, where W denotes a subset of K (i.e., the set of local features for the decision tree 601), Z denotes a subset of W, and \tilde{Z} denotes the set of features that are in K but are not in Z.

With the marginal path expectations computed and the weights known, the formula ϕᵢ(a) can be evaluated for each feature i for the leaf a into which an input data record falls in the decision tree 601. The formula ϕᵢ(a) can be similarly evaluated for each feature i for each leaf into which the input data record falls in the other decision trees of the ensemble 600. The sum of the Shapley values for a feature i across the leaves in the ensemble 600 into which the input data record lands can then be summed to determine the overall Shapley value for the ensemble 600.

The formula ϕᵢ(a) can also be evaluated to determine each of the features to determine the respective set of Shapley values to which each leaf in the ensemble 600 maps. The determined Shapley values can then be stored in a data structure that maps leaves to sets of Shapley values to facilitate rapid retrieval and to obviate repeating any calculations when Shapley values are requested for input data instances provided thereafter.

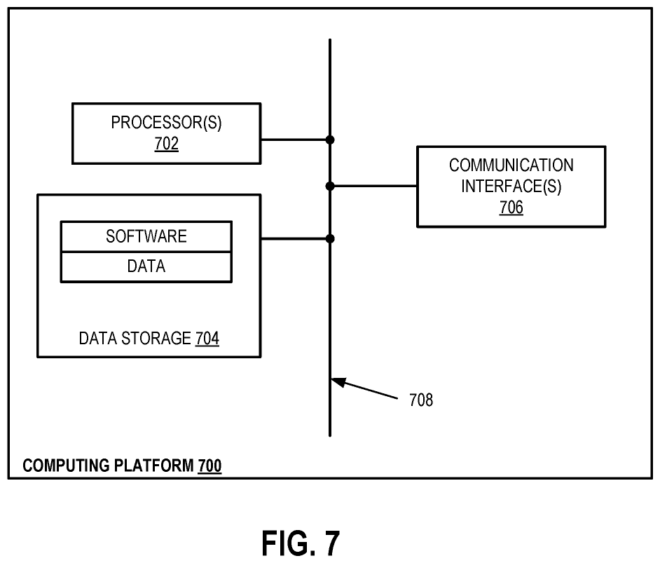

Turning now to FIG. 7, a simplified block diagram is provided to illustrate some structural components that may be included in an example computing platform 700 that may be configured to perform some or all of the functions discussed herein for creating a data science model in accordance with the present disclosure. At a high level, computing platform 700 may generally comprise any one or more computer systems (e.g., one or more servers) that collectively include one or more processors 702, data storage 704, and one or more communication interfaces 706, all of which may be communicatively linked by a communication link 708 that may take the form of a system bus, a communication network such as a public, private, or hybrid cloud, or some other connection mechanism. Each of these components may take various forms.

For instance, the one or more processors 702 may comprise one or more processor components, such as one or more central processing units (CPUs), graphics processing units (GPUs), application-specific integrated circuits (ASICs), digital signal processor (DSPs), and/or programmable logic devices such as a field programmable gate arrays (FPGAs), among other possible types of processing components. In line with the discussion above, it should also be understood that the one or more processors 702 could comprise processing components that are distributed across a plurality of physical computing devices connected via a network, such as a computing cluster of a public, private, or hybrid cloud.

In turn, data storage 704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 704 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 7, data storage 704 may be capable of storing both (i) program instructions that are executable by processor 702 such that the computing platform 700 is configured to perform any of the various functions disclosed herein (including but not limited to any the functions described above with reference to FIGS. 3A-3B), and (ii) data that may be received, derived, or otherwise stored by computing platform 700.

The one or more communication interfaces 706 may comprise one or more interfaces that facilitate communication between computing platform 700 and other systems or devices, where each such interface may be wired and/or wireless and may communicate according to any of various communication protocols, examples of which may include Ethernet, Wi-Fi, serial bus (e.g., Universal Serial Bus (USB) or Firewire), cellular network, and/or short-range wireless protocols, among other possibilities.

Although not shown, the computing platform 700 may additionally include or have an interface for connecting to one or more user-interface components that facilitate user interaction with the computing platform 700, such as a keyboard, a mouse, a trackpad, a display screen, a touch-sensitive interface, a stylus, a virtual-reality headset, and/or one or more speaker components, among other possibilities.

It should be understood that computing platform 700 is one example of a computing platform that may be used with the examples described herein. Numerous other arrangements are possible and contemplated herein. For instance, other computing systems may include additional components not pictured and/or more or less of the pictured components.

### CONCLUSION

This disclosure makes reference to the accompanying figures and several examples. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one processor;
non-transitory computer-readable medium; and
program instructions stored on the non-transitory computer-readable medium that are executable by the at least one processor such that the computing platform is configured to:
receive a request to compute a score for an input data record, the input data record comprising a group of actual parameters that map to a set of features that a trained data science model is configured to receive as input;
input the group of actual parameters into the trained data science model, wherein the trained data science model comprises an ensemble of decision trees, and wherein:
each individual decision tree in the ensemble is symmetric,
each individual decision tree in the ensemble is configured to receive a respective subset of the features as input, and
within each individual decision tree, internal nodes that are positioned in a same level designate a same splitting criterion based on a same feature selected from the respective subset of features;
for each individual decision tree in the ensemble:
identify a respective leaf such that the actual parameters satisfy a series of splitting conditions for edges that connect nodes in a respective path from a root of the individual decision tree to the respective leaf, and
determine a set of respective individual contribution values for the respective leaf, wherein each of the respective individual contribution values maps to a respective feature found in the respective subset of features;
for each individual feature in the set of features, compute a respective overall contribution value based on a sum of the respective individual contribution values that map to that individual feature; and
compute, via the trained data science model, the score for the input data record based on the respective leaves identified.

2. The computing platform of claim 1, wherein the program instructions that are executable by the at least one processor comprise program instructions that are executable by the at least one processor such that the computing platform is configured to:
identify at least one a reason code for the score based on the respective overall contribution values for the individual features in the set of features; and
transmit the score and the at least one reason code in response to the request.

3. The computing platform of claim 1, wherein the program instructions that are executable by the at least one processor comprise program instructions that are executable by the at least one processor such that the computing platform is configured to:
prior to receiving the request, train the trained data science model against training data that comprises a plurality of training data records.

4. The computing platform of claim 3, wherein determining the set of respective individual contribution values for the respective leaf comprises:
identifying each realizable path from the root of the individual decision tree to each realizable leaf in the individual decision tree, respectively;
for each identified realizable path, computing a respective first probability by dividing a number of the training data records that were scored during the training based on the identified realizable path by a total number of training data records in the training data;
for each identified realizable path, identifying a respective score to be assigned to input data records scored by the identified realizable path;
for each level of the individual decision tree, identifying the same feature on which the same splitting criterion specified by the internal nodes at that level is based;
identifying subsets of the respective subset of features that the individual decision tree is configured to receive as input;
for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree;
for each identified subset of the respective subset of features, computing a sum of the respective first probabilities for each realizable path in the identified subset; and
for each identified subset of the respective subset of features, computing a marginal path expectation by multiplying the respective score for the respective path by the sum for the identified subset.

5. The computing platform of claim 4, wherein identifying each realizable path from the root of the individual decision tree to each realizable leaf in the individual decision tree, respectively, comprises:
identifying a selected path to be evaluated for realizability;
detecting that a first splitting condition for a first edge in the selected path and a second splitting condition for a second edge in the path contradict each other; and
excluding the selected path from a list of realizable paths.

6. The computing platform of claim 1, wherein determining the set of respective individual contribution values for the respective leaf comprises:
receiving an identifier of a leaf selected from a decision tree in the ensemble; and
based on the identifier of the leaf, determining a set of contribution values to which the identifier maps in a data structure, wherein the determined set of contribution values to which the identifier maps in the data structure is the set of respective individual contribution values.

7. The computing platform of claim 6, wherein the program instructions that are executable by the at least one processor comprise program instructions that are executable by the at least one processor such that the computing platform is configured to:
prior to receiving the request, generate a respective set of contribution values for each leaf in the ensemble of decision trees and populating the data structure with entries that map the leaves in the ensemble of decision trees to the respective sets of contribution values, wherein generating a respective set of contribution values comprises:
identifying each realizable path from the root of the individual decision tree to each realizable leaf in the individual decision tree, respectively;
for each identified realizable path, computing a respective first probability by dividing a number of the training data records that were scored during the training based on the identified realizable path by a total number of training data records in the training data;
for each identified realizable path, identifying a respective score to be assigned to input data records scored by the identified realizable path;
for each level of the individual decision tree, identifying the same feature on which the same splitting criterion specified by the internal nodes at that level is based;
identifying subsets of the respective subset of features that the individual decision tree is configured to receive as input;
for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree;
for each identified subset of the respective subset of features, computing a sum of the respective first probabilities for each realizable path in the identified subset; and
for each identified subset of the respective subset of features, computing a marginal path expectation by multiplying the respective score for the respective path by the sum for the identified subset.

8. The computing platform of claim 2, wherein the at least one reason code comprises a model reason code (MRC) or an adverse action reason code (AARC).

9. A non-transitory computer-readable medium, wherein the non-transitory computer-readable medium is provisioned with program instructions that, when executed by at least one processor, cause a computing platform to:
receive a request to compute a score for an input data record, the input data record comprising a group of actual parameters that map to a set of features that a trained data science model is configured to receive as input;
input the group of actual parameters into the trained data science model, wherein the trained data science model comprises an ensemble of decision trees, and wherein:
each individual decision tree in the ensemble is symmetric,
each individual decision tree in the ensemble is configured to receive a respective subset of the features as input, and
within each individual decision tree, internal nodes that are positioned in a same level designate a same splitting criterion based on a same feature selected from the respective subset of features;
for each individual decision tree in the ensemble:
identify a respective leaf such that the actual parameters satisfy a series of splitting conditions for edges that connect nodes in a respective path from a root of the individual decision tree to the respective leaf, and
determine a set of respective individual contribution values for the respective leaf, wherein each of the respective individual contribution values maps to a respective feature found in the respective subset of features;
for each individual feature in the set of features, compute a respective overall contribution value based on a sum of the respective individual contribution values that map to that individual feature; and
compute, via the trained data science model, the score for the input data record based on the respective leaves identified.

10. The non-transitory computer-readable medium of claim 9, wherein the program instructions that, when executed by at least one processor, further comprise program instructions that, when executed by at least one processor, cause the computing platform to:
identify at least one a reason code for the score based on the respective overall contribution values for the individual features in the set of features; and
transmit the score and the at least one reason code in response to the request.

11. The non-transitory computer-readable medium of claim 9, wherein the program instructions that, when executed by at least one processor, further comprise program instructions that, when executed by at least one processor, cause the computing platform to:
prior to receiving the request, train the trained data science model against training data that comprises a plurality of training data records.

12. The non-transitory computer-readable medium of claim 11, wherein determining the set of respective individual contribution values for the respective leaf comprises:
identifying each realizable path from the root of the individual decision tree to each realizable leaf in the individual decision tree, respectively;
for each identified realizable path, computing a respective first probability by dividing a number of the training data records that were scored during the training based on the identified realizable path by a total number of training data records in the training data;
for each identified realizable path, identifying a respective score to be assigned to input data records scored by the identified realizable path;
for each level of the individual decision tree, identifying the same feature on which the same splitting criterion specified by the internal nodes at that level is based;
identifying subsets of the respective subset of features that the individual decision tree is configured to receive as input;
for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree;
for each identified subset of the respective subset of features, computing a sum of the respective first probabilities for each realizable path in the identified subset; and
for each identified subset of the respective subset of features, computing a marginal path expectation by multiplying the respective score for the respective path by the sum for the identified subset.

13. The non-transitory computer-readable medium of claim 12, wherein identifying each realizable path from the root of the individual decision tree to each realizable leaf in the individual decision tree, respectively, comprises:
identifying a selected path to be evaluated for realizability;
detecting that a first splitting condition for a first edge in the selected path and a second splitting condition for a second edge in the path contradict each other; and
excluding the selected path from a list of realizable paths.

14. The non-transitory computer-readable medium of claim 9, wherein determining the set of respective individual contribution values for the respective leaf comprises:
receiving an identifier of a leaf selected from a decision tree in the ensemble; and
based on the identifier of the leaf, determining a set of contribution values to which the identifier maps in a data structure, wherein the determined set of contribution values to which the identifier maps in the data structure is the set of respective individual contribution values.

15. The non-transitory computer-readable medium of claim 14, wherein the program instructions that, when executed by at least one processor, further comprise program instructions that, when executed by at least one processor, cause the computing platform to:
prior to receiving the request, generate a respective set of contribution values for each leaf in the ensemble of decision trees and populating the data structure with entries that map the leaves in the ensemble of decision trees to the respective sets of contribution values, wherein generating a respective set of contribution values comprises:
identifying each realizable path from the root of the individual decision tree to each realizable leaf in the individual decision tree, respectively;
for each identified realizable path, computing a respective first probability by dividing a number of the training data records that were scored during the training based on the identified realizable path by a total number of training data records in the training data;
for each identified realizable path, identifying a respective score to be assigned to input data records scored by the identified realizable path;
for each level of the individual decision tree, identifying the same feature on which the same splitting criterion specified by the internal nodes at that level is based;
identifying subsets of the respective subset of features that the individual decision tree is configured to receive as input;
for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree;
for each identified subset of the respective subset of features, computing a sum of the respective first probabilities for each realizable path in the identified subset; and
for each identified subset of the respective subset of features, computing a marginal path expectation by multiplying the respective score for the respective path by the sum for the identified subset.

16. A method carried out by a computing platform, the method comprising:
receiving a request to compute a score for an input data record, the input data record comprising a group of actual parameters that map to a set of features that a trained data science model is configured to receive as input;
inputting the group of actual parameters into the trained data science model, wherein the trained data science model comprises an ensemble of decision trees, and wherein:
each individual decision tree in the ensemble is symmetric,
each individual decision tree in the ensemble is configured to receive a respective subset of the features as input, and
within each individual decision tree, internal nodes that are positioned in a same level designate a same splitting criterion based on a same feature selected from the respective subset of features;
for each individual decision tree in the ensemble:
identifying a respective leaf such that the actual parameters satisfy a series of splitting conditions for edges that connect nodes in a respective path from a root of the individual decision tree to the respective leaf, and
determining a set of respective individual contribution values for the respective leaf, wherein each of the respective individual contribution values maps to a respective feature found in the respective subset of features;
for each individual feature in the set of features, computing a respective overall contribution value based on a sum of the respective individual contribution values that map to that individual feature; and
computing, via the trained data science model, the score for the input data record based on the respective leaves identified.

17. The method of claim 16, further comprising:
identifying at least one a reason code for the score based on the respective overall contribution values for the individual features in the set of features; and
transmitting the score and the at least one reason code in response to the request.

18. The method of claim 16, further comprising:
prior to receiving the request, training the trained data science model against training data that comprises a plurality of training data records.

19. The method of claim 19, wherein determining the set of respective individual contribution values for the respective leaf comprises:
identifying each realizable path from the root of the individual decision tree to each realizable leaf in the individual decision tree, respectively;
for each identified realizable path, computing a respective first probability by dividing a number of the training data records that were scored during the training based on the identified realizable path by a total number of training data records in the training data;
for each identified realizable path, identifying a respective score to be assigned to input data records scored by the identified realizable path;
for each level of the individual decision tree, identifying the same feature on which the same splitting criterion specified by the internal nodes at that level is based;
identifying subsets of the respective subset of features that the individual decision tree is configured to receive as input;
for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree;
for each identified subset of the respective subset of features, computing a sum of the respective first probabilities for each realizable path in the identified subset; and
for each identified subset of the respective subset of features, computing a marginal path expectation by multiplying the respective score for the respective path by the sum for the identified subset.

20. The method of claim 19, wherein identifying each realizable path from the root of the individual decision tree to each realizable leaf in the individual decision tree, respectively, comprises:
identifying a selected path to be evaluated for realizability;
detecting that a first splitting condition for a first edge in the selected path and a second splitting condition for a second edge in the path contradict each other; and
excluding the selected path from a list of realizable paths.
